(19) United States
(12) Patent Application Publication
(10) Pub. No.: US 2023/0169948 A1
(43) Pub. Date: Jun. 1, 2023

(54) SIGNAL PROCESSING DEVICE, SIGNAL PROCESSING PROGRAM, AND SIGNAL PROCESSING METHOD

(71) Applicant: SONY GROUP CORPORATION, TOKYO (JP)

(72) Inventor: YUSHI YAMABE, TOKYO (JP)

(21) Appl. No.: 17/997,630

(22) PCT Filed: Apr. 28, 2021
(86) PCT No.: PCT/JP2021/016929

§ 371 Date: Oct. 31, 2022

(30) Foreign Application Priority Data
May 7, 2020 (JP) 2020-082200

(51) Int. Cl. G10K 11/178; H04R 1/10

(52) U.S. Cl. CPC G10K 11/17823; G10K 11/17825; G10K 11/17881; H04R 1/1083; G10K 2210/1081; G10K 2210/3026; G10K 2210/3027; G10K 2210/3028; G10K 2210/3044; G10K 2210/3055; G10K 2210/3056; H04R 2460/01

(57) ABSTRACT

A signal processing device according to an embodiment includes: two or more microphones each provided with a sound collection unit directed to an outside of a housing including a driver unit, a control unit (102b) that performs a hearing control of sound output from the driver unit to a listener based on sound signals collected and output by the two or more microphones, and an adjustment unit (200) that adjusts a degree of the hearing control between a degree for wind and a degree for non-wind based on a correlation between the sound signals.

### FIELD

The present disclosure relates to a signal processing device, a signal processing program, and a signal processing method.

### BACKGROUND

In a known noise canceling system, a microphone for collecting external sound is provided in a housing of a sound output apparatus (hereinafter referred to as a head-mounted type sound output apparatus) used by being worn on a head or an outer ear such as a headphone or an earphone, and signal processing is performed based on the sound collected by the microphone to remove sound (external noise) reaching an auricle from outside. In this noise canceling system, for example, the external noise is removed by adding a sound signal opposite in phase from a sound signal of the sound collected by the microphone to a sound signal that is to be originally output by the head-mounted sound output apparatus.

When the microphone provided in the housing of the head-mounted sound output apparatus is exposed to wind environment, noise (wind noise) generated by the wind coming to the microphone is mixed in the sound collected by the microphone. Since the wind noise has no correlation with the external noise, there is a possibility that the wind noise has an undesirable influence on an external noise removal process by the noise canceling system, and user may feel discomfort.

In order to reduce the wind noise, it is conceivable to provide the microphone at a position where the wind noise is less likely to occur. Furthermore, it is also conceivable to perform a filtering process specialized for suppressing wind noise on the sound collected by the microphone.

### CITATION LIST

### Patent Literature

Patent Literature 1: JP 2009 049885 A

### SUMMARY

### Technical Problem

However, a position of a microphone effective for reducing wind noise does not always coincide with a position of the microphone effective for removing external noise. In addition, a filtering process suitable for reducing the wind noise and a filtering process suitable for removing the external noise are also different. Therefore, conventionally, it has been difficult to suppress influence of wind noise on removal of external noise.

It is therefore an object of the present disclosure to provide a signal processing device, a signal processing program, and a signal processing method capable of suppressing the influence of wind noise on the removal of external noise. Solution to Problem

For solving the problem described above, a signal processing device according to one aspect of the present disclosure has two or more microphones each provided with a sound collection part directed to an outside of a housing including a driver unit; a control unit that performs a hearing control on sound output from the driver unit to a listener based on each of sound signals collected and output by each of the two or more microphones; and an adjustment unit that adjusts a degree of the hearing control, based on a correlation between the sound signals, between a degree for wind and a degree for non-wind.

### BRIEF DESCRIPTION OF DRAWINGS

FIG. 1A is a diagram illustrating an example of a configuration of an FB noise canceling system.

FIG. 1B is a diagram illustrating an example of a configuration of the FB noise canceling system.

FIG. 1C is a diagram illustrating an example of a configuration of the FB noise canceling system.

FIG. 2 is a diagram illustrating an example of a Bode plot.

FIG. 3A is a diagram illustrating an example of a configuration of an FF noise canceling system.

FIG. 3B is a diagram illustrating an example of a configuration of the FF noise canceling system.

FIG. 3C is a diagram illustrating an example of a configuration of the FF noise canceling system.

FIG. 4 is a diagram defining transfer functions of an FB noise canceller using IMC.

FIG. 5A is a diagram illustrating an example of a configuration of a system capable of realizing an HT function.

FIG. 5B is a diagram illustrating an example of a configuration of the system capable of realizing the HT function.

FIG. 5C is a diagram illustrating an example of a configuration of the system capable of realizing the HT function.

FIG. 6 is a schematic diagram illustrating a comparison between the FF noise canceling system and an HT system.

FIG. 7 is a schematic diagram illustrating an appearance example of a true wireless earphone.

FIG. 8 is a schematic diagram illustrating an appearance example of an over-ear type headphone.

FIG. 9 is a schematic diagram illustrating an incoming noise direction when an earphone is worn on a head of a listener.

FIG. 10 is a diagram illustrating an example of amplitude characteristics of a transfer function “α” with respect to incoming noise from different directions.

FIG. 11 is a diagram illustrating an example of a filter configuration when N microphones are provided in the earphone or the headphone.

FIG. 12A is a schematic diagram illustrating an example of a position of the microphone arranged in the earphone.

FIG. 12B is a schematic diagram illustrating an example of a position of the microphone arranged in the headphone.

FIG. 13 is a diagram illustrating an example of a configuration of an FF noise canceling system in consideration of wind noise.

FIG. 14 is a flowchart illustrating an example of a wind noise detection process according to a first embodiment.

FIG. 15A is a hardware block diagram of an example of a sound output apparatus including a signal processing device according to the first embodiment.

FIG. 15B is a hardware block diagram of an example of the sound output apparatus including the signal processing device according to the first embodiment.

FIG. 16 is a block diagram illustrating an example of control by a wind noise detection and control unit according to the first embodiment.

FIG. 17 is a block diagram illustrating an example of control by a wind noise detection and control unit according to a first modification of the first embodiment.

FIG. 18 is a block diagram illustrating an example of control by a wind noise detection and control unit according to a second modification of the first embodiment.

FIG. 19 is a block diagram illustrating an example of control by a wind noise detection and control unit according to a third modification of the first embodiment.

FIG. 20 is a block diagram illustrating an example of control by a wind noise detection and control unit according to a fourth modification of the first embodiment.

FIG. 21 is a block diagram illustrating an example of control by a wind noise detection and control unit according to a fifth modification of the first embodiment.

FIG. 22 is a block diagram illustrating an example of control by a wind noise detection and control unit according to a sixth modification of the first embodiment.

FIG. 23 is a block diagram illustrating an example of control by a wind noise detection and control unit according to a seventh modification of the first embodiment.

FIG. 24 is a functional block diagram illustrating an example of control by a wind noise detection and control unit according to a second embodiment.

FIG. 25 is a block diagram illustrating an example of control by a wind noise detection and control unit according to a first modification of the second embodiment.

FIG. 26 is a block diagram illustrating an example of control by a wind noise detection and control unit according to a second modification of the second embodiment.

FIG. 27 is a block diagram illustrating an example of control by a wind noise detection and control unit according to a third modification of the second embodiment.

FIG. 28 is a block diagram illustrating an example of control by a wind noise detection and control unit according to a fourth modification of the second embodiment.

FIG. 29 is a block diagram illustrating an example of control by a wind noise detection and control unit according to a fifth modification of the second embodiment.

FIG. 30 is a block diagram illustrating an example of control by a wind noise detection and control unit according to a sixth modification of the second embodiment.

FIG. 31 is a block diagram illustrating an example of control by a wind noise detection and control unit according to a seventh modification of the second embodiment.

FIG. 32 is a hardware block diagram of an example of a sound output apparatus according to a third embodiment.

FIG. 33 is a diagram illustrating an example of a configuration of an FF noise canceling system according to the third embodiment.

FIG. 34 is a schematic diagram illustrating an example of an operation according to a detection result of a sensor according to the third embodiment.

### DESCRIPTION OF EMBODIMENTS

Hereinafter, embodiments of the present disclosure will be described in detail with reference to the drawings. Note that, in the following embodiments, same parts are denoted by same reference signs to omit redundant description.

Hereinafter, the embodiments of the present disclosure will be described in the following order.
1. Outline of present disclosure
2. Technology applicable to each embodiment
   2-1. FB noise canceller
   2-2. FF noise canceller
   2-3. IMC noise canceller
   2-4. External sound capturing method
   2-5. Number of microphones
3. Embodiments
   3-1. Known problems in conventional technology
4. First embodiment
   4-1. Configuration example of first embodiment
      4-1-1. Control according to detection result of wind noise
   4-2. First modification of first embodiment
   4-3. Second modification of first embodiment
   4-4. Third modification of first embodiment
   4-5. Fourth modification of first embodiment
   4-6. Fifth modification of first embodiment
   4-7. Sixth modification of first embodiment
   4-8. Seventh modification of first embodiment
5. Second embodiment
   5-1. Configuration example of second embodiment
      5-1-1. Control according to detection result of wind noise
   5-2. First modification of second embodiment
   5-3. Second modification of second embodiment
   5-4. Third modification of second embodiment
   5-5. Fourth modification of second embodiment
   5-6. Fifth modification of second embodiment
   5-7. Sixth modification of second embodiment
   5-8. Seventh modification of second embodiment
6. Third embodiment

### 1. Outline of Present Disclosure

First, an outline of the present disclosure will be described. A signal processing device according to the present disclosure performs signal processing on a sound signal supplied to a sound output apparatus used by being worn on a head or an ear. The sound output apparatus applicable to the present disclosure includes an over-ear (or on-ear) headphone (hereinafter referred to as a headphone) that supplies sound generated by vibration of a diaphragm according to a sound signal in a driver unit to near an auricle of a listener, and an inner-ear (or canal) earphone (hereinafter referred to as an earphone) that directly supplies the sound to the auricle of the listener.

Furthermore, the sound output apparatus is provided with a microphone capable of collecting external sound (e.g., external noise) that is sound coming from outside a housing including the driver unit. The signal processing device according to the present disclosure performs a noise canceling process capable of reducing the external noise included in the sound supplied to the auricle of the listener based on a sound signal collected by the microphone.

Furthermore, the signal processing device according to the present disclosure can also execute a process of actively supplying the external sound to the auricle of the listener by performing predetermined signal processing on the sound signal of the external sound collected by the microphone and adding a processed signal to a sound source signal that is to be originally reproduced by the driver unit. In this case, for example, by adding, to the sound source signal, a frequency band component of a voice in the sound signal obtained by collecting the external sound, the listener can easily listen to a speaking voice of surrounding people while wearing the headphone or earphone. Addition of the sound signal obtained by collecting the external sound to the sound source signal is referred to as an ambient sound monitor.

The signal processing device according to the present disclosure suppresses an influence of wind noise on the above-described noise canceling or ambient sound monitor. Although details will be described later, when wind hits the microphone provided in the sound output apparatus so as to collect the external sound, turbulence occurs around the microphone, and noise generated by the turbulence (hereinafter referred to as wind noise as appropriate) is collected by the microphone. This wind noise affects the noise cancellation or the ambient sound monitor described above, and may give discomfort to the listener.

In the present disclosure, a presence or absence of wind noise is detected based on a correlation between sound signals obtained from sound collected by a plurality of microphones provided in the housing of the sound output apparatus. Then, when generation of the wind noise is detected, a process of reducing the influence of wind noise on the noise cancellation or the ambient sound monitor is executed.

### 2. Technology Applicable to Each Embodiment

Prior to the description of the present disclosure, a technology applicable to each embodiment will be described for ease of understanding. First, a basic configuration of a noise canceling system applicable to the present disclosure will be described.

### 2-1. FB Noise Canceling System

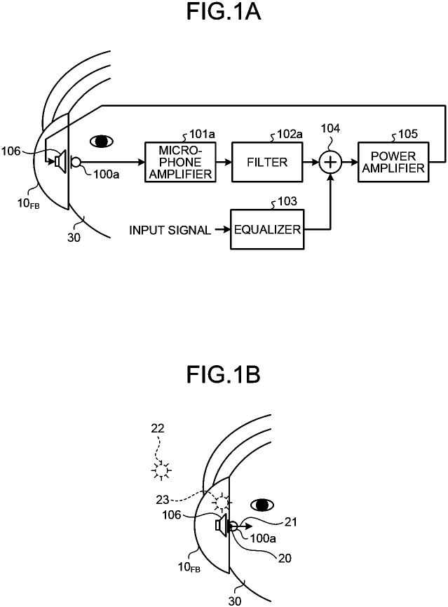

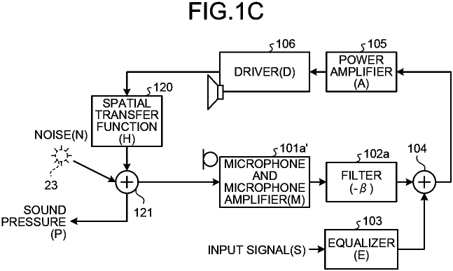

First, a noise canceling system (noise canceller) using an existing feedback system (hereinafter referred to as FB) will be described. FIGS. 1A, 1B, and 1C are diagrams illustrating examples of a configuration of an FB noise canceling system.

FIG. 1A is a block diagram illustrating the example of an electric circuit configuration of the FB noise canceling system. In this example, an overhead type headphone 10_{FB} used by being worn on a head 30 of the listener is applied to the sound output apparatus. The headphone 10_{FB} includes a microphone 100a and a driver unit 106. The driver unit 106 is provided with, for example, a diaphragm. Air vibration based on a sound signal is generated by vibrating the diaphragm according to the sound signal supplied, thereby outputting a sound.

In the headphone 10_{FB}, a space on an auricle side of the driver unit 106 and a space facing the space via the driver unit 106 are generally separated by a partition wall or the like. Hereinafter, a surface of the driver unit 106 on the auricle side is referred to as a front surface, and a surface facing the front surface is referred to as a rear surface.

The microphone 100a is provided in a space on the front surface of the driver unit 106 inside the housing (housing part) of the headphone 10_{FB}, and collects sound in the space. In other words, the microphone 100a directly collects the sound in the space, that is, the sound guided to the auricle of the listener. The sound signal based on the sound collected by the microphone 100a is supplied to a filter 102a supporting the FB system, which will be described in detail later, via a microphone amplifier 101a. The sound signal filtered by the filter 102a is supplied to an adder 104.

On the other hand, an input signal by the sound signal as a sound source is supplied to the adder 104 via an equalizer 103 having characteristics to be described in detail later. The adder 104 supplies a sound signal obtained by adding the output of the filter 102a and the output of the equalizer 103 to a power amplifier 105. The power amplifier 105 power-amplifies the sound signal supplied and supplies the sound signal amplified to the driver unit 106. The driver unit 106 is driven according to the sound signal supplied from the power amplifier 105 to output a sound. The microphone 100a collects the sound output by the driver unit 106 and sound (external noise) coming from outside of the headphone 10_{FB}.

FIG. 1B is a diagram illustrating each sound related to the headphone 10_{FB}. In FIG. 1B, noise 22 is the external noise due to a noise source outside the headphone 10_{FB}. Furthermore, noise 23 is the noise 22 entering the headphone 10_{FB}. In the headphone 10_{FB}, the noise 23 and a sound pressure 21 generated based on the sound signal in the driver unit 106 reach the auricle in the head 30 on which the headphone 10_{FB} is worn.

A control point 20 indicates a position where the noise 23 is reduced in the noise canceling system including the headphone 10_{FB}. In a case of the FB system, the control point 20 is at a position corresponding to the microphone 100a. In the example in FIG. 1B, a position close to the auricle, such as a front surface of the diaphragm of the driver unit 106, is the control point 20, and the microphone 100a is arranged at a position corresponding to the control point 20.

FIG. 1C is a diagram defining a transfer function for each part illustrated in FIG. 1A. In FIG. 1C, the driver unit 106 is referred to as a “driver 106”. As indicated in parentheses after a name of each block, the transfer function of a microphone and microphone amplifier 101a′ that integrates the microphone 100a and microphone amplifier 101a is denoted by “M”, the transfer function of the filter 102a is denoted by “-β”, the transfer function of the power amplifier is denoted by “A”, the transfer function of the driver 106 is denoted by “D”, and the transfer function of the equalizer 103 is denoted by “E”. Furthermore, a spatial transfer function 120 is a transfer function from the driver 106 to the microphone 100a, and is denoted by “H”. It is assumed that each transfer function is expressed by complex representation.

Furthermore, the noise 22 in which the external noise 22 illustrated in FIG. 1B entering the headphone 10_{FB} is denoted by “N”. A cause of the noise 22 being transmitted to inside the headphone 10_{FB} is, for example, a sound pressure leaking through a gap of an ear pad (an ear piece for an in-ear type) provided on a portion where the headphone 10_{FB} contacts skin. Other conceivable causes include a hole provided to reach outside from the front surface of the headphone 10_{FB} and sound transmitted inside the housing as a result of vibration of the housing of the headphone 10_{FB} receiving the sound pressure.

An adder 121 indicates that the output of driver unit 106 and the noise 23 are collected by the microphone 100a, and corresponds to the control point 20. In other words, the spatial transfer function “H” is equivalent to a transfer function from the driver unit 106 to the control point 20. Furthermore, sound obtained by adding the output of the driver unit 106b and the noise 23 reaches the auricle as a sound pressure. This sound pressure is denoted by “P”. Further, the input signal is “S”.

A relationship between the blocks in FIG. 1C can be expressed by Expression (1) below using the transfer functions.

$$\text{P} = \frac{1}{1 + \text{ADHM} β} \text{N} + \frac{\text{AHD}}{1 + \text{ADHM} β} \text{ES}$$

In Expression (1), focusing on “N” indicating the noise 23, it can be seen that the noise 23 attenuates to “1/(1 + ADHMβ)”. Here, for stable operation without oscillation of a system of Expression (1), it is necessary to satisfy a condition represented by Expression (2) below.

$$\left|\frac{1}{1 + \text{ADHM} β}\right| < 1$$

In general, in addition to “1 << | ADMHβ | , Expression (2) can be interpreted as follows.

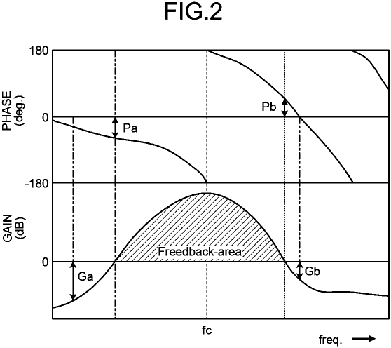

In FIG. 1C, “-ADMHβ” is an open loop obtained by cutting a loop related to “N” indicating the noise 23 at one place, and has a characteristic expressed by, for example, a Bode diagram illustrated in FIG. 2. In a case of this open loop, the condition of the above Expression (2) needs to satisfy two conditions (1) and (2) as follows.
(1) A gain is less than 0 [dB] at passing a point of phase 0 [deg].
(2) When the gain is 0 [dB] or more, the point of phase 0 [deg] is not included.

When the conditions (1) and (2) are not satisfied, positive feedback is applied to the loop and oscillation (howling) occurs. In FIG. 2, margins Pa and Pb represent phase margins, and margins Ga and Gb represent gain margins. When the margins Pa and Pb and the margins Ga and Gb are small, a possibility of oscillation increases due to, for example, individual differences in a face shape and variations in a wearing state of the headphone 10_{FB}.

Next, in addition to a reduction function of the above-described noise coming from outside, reproduction of sound of the input signal by the headphone 10_{FB} will be described. The input signal “S” in FIG. 1C is a sound signal of a sound to be originally reproduced by the driver unit 106 of the headphone 10_{FB}, and includes a music signal, sound of a microphone outside the housing (when used as a hearing aid function), and a voice signal via communication (when used as a headset).

Focusing on the input signal “S” in the above Expression (1), when the transfer function “E” of the equalizer 103 is set as in Expression (3) below, the sound pressure “P” is expressed as in Expression (4) below.

$$\text{E} = \left(1 + \text{ADHM} β\right)$$

$$\text{P} = \frac{1}{1 + \text{ADHM} β} \text{N} + \text{AHDS}$$

Assuming that the position of the microphone 100a is very close to the position of the auricle, the transfer function “H” can be considered as a transfer function from the driver unit 106 to the microphone 100a (auricle). Here, since the transfer functions “A″ and” D″ are the transfer functions of the power amplifier 105 and the driver unit 106, respectively, it can be seen that characteristics similar to those of the headphone without noise reduction function can be obtained.

### 2-2. FF Noise Canceling System

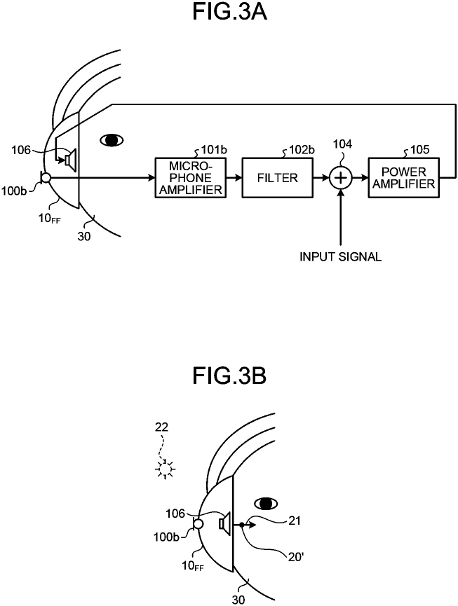

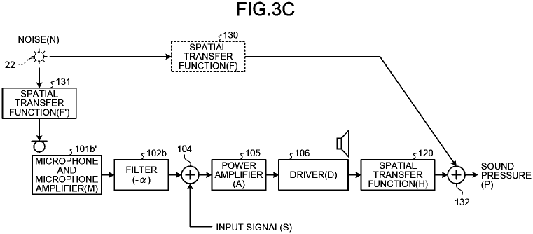

Next, a noise canceling system (noise canceller) using an existing feed-forward system (hereinafter referred to as FF) will be described. FIGS. 3A, 3B, and 3C are diagrams illustrating examples of a configuration of an FF noise canceling system.

FIG. 3A is a block diagram illustrating the example of an electric circuit configuration of the FF noise canceling system. In the configuration illustrated in FIG. 3A, a filter 102b having a characteristic supporting the FF system is provided instead of the filter 102a in the configuration illustrated in FIG. 1A described above. An input signal is directly input to the adder 104. Furthermore, in a headphone 10_{FF}, a microphone 100b for collecting external noise is arranged on a surface of a housing of the headphone 10_{FF}. In other words, the microphone 100b is provided outward on the housing of the headphone 10_{FF}. A non-directional microphone is used as the microphone 100b.

A sound signal based on a sound collected by the microphone 100b is input to the filter 102b via a microphone amplifier 101b. The sound signal output from the filter 102b is combined with the input signal in the adder 104 and input to the power amplifier 105.

Note that, in the example in FIG. 3A, the equalizer 103 is omitted from the configuration in FIG. 1A, but the configuration is not limited thereto, and the equalizer 103 may be provided similarly to the configuration in FIG. 1A.

FIG. 3B is a diagram illustrating each sound related to the headphone 10_{FF}. In FIG. 3B, the microphone 100b collects noise 22 due to a noise source outside the headphone 10_{FF}. Furthermore, in the example in FIG. 3B, a control point 20′ is located at a position close to the auricle on the front surface of the driver unit 106, similarly to the headphone 10_{FB} illustrated in FIG. 1B. In the FF system, the control point 20′ can be set at an arbitrary auricle position of the listener.

FIG. 3C is a diagram defining a transfer function for each part illustrated in FIG. 3A. In FIG. 3C, the driver unit 106 is referred to as the “driver 106”. In this example, a transfer function “M” is a transfer function of a microphone and microphone amplifier 101b′ that integrates the microphone 100b and the microphone amplifier 101b. Furthermore, a transfer function of the filter 102b is denoted by “-α”, and the spatial transfer function 120 from the driver unit 106 to an adder 132 corresponding to the control point 20 is denoted by “H”. Furthermore, a spatial transfer function 130 until the noise 22, which is the external noise, reaches the control point 20 (adder 132) via the housing of the headphone 10_{FF} is denoted by “F”, and a spatial transfer function 131 until the noise 22 reaches the microphone 100b is denoted by “F′”.

A relationship between the blocks in FIG. 3C can be expressed by Expression (5) below using the transfer functions.

$$\text{P} = - \text{F′ADHM} α \text{N} + \text{FN} + \text{ADHS}$$

Here, an ideal state is considered, and the spatial transfer function “F” (spatial transfer function 130) is expressed by Expression (6) below. In this case, Expression (5) described above can be expressed by Expression (7) below.

$$\text{F} = {\text{F}}^{′} \text{ADHM} α$$

$$\text{P} = \text{ADHS}$$

According to Expression (7), the input signal “S” remains but the noise “N” is not included in the sound pressure “P”. Therefore, it can be seen that the noise is canceled, and a sound equivalent to the normal headphone operation (i.e., operation in a state where the external noise 22 does not exist) can be heard.

Here, practically speaking, it is difficult to configure a perfect filter 102b having the transfer function “-α” completely satisfying Expression (6). In particular, regarding a middle and high ranges, characteristics change depending on individual differences in a wearing state or an ear shape of listeners, a position of a generation source of the noise 22, a position of the microphone 100b, and the like. Therefore, in general, passive sound insulation such as enhancement of sealing of the housing of the headphone 10_{FF} from external sound is often performed without performing an active noise reduction process according to FIG. 3C.

Note that Expression (6) signifies that the spatial transfer function “F′” (spatial transfer function 131) from the noise source of the noise 22 to the auricle position is imitated by the electric circuit including the transfer function “-α” of the filter 102b.

As described above, in the FF system, the control point 20′ can be set at the arbitrary auricle position of the listener. On the other hand, in general, the transfer function “-α” of the filter 102b is fixed, and it is necessary to design the filter 102b in a limited manner for some target characteristic in the design stage. In this case, depending on the listener, the auricle shape is different from the shape assumed at the time of designing, and a sufficient noise cancellation effect may not be obtained. Or, noise components are added in a non-inverted phase, and a phenomenon such as abnormal noise may occur.

Accordingly, the FF system has a low possibility of oscillation and high stability, but it is generally difficult to achieve sufficient noise attenuation. On the other hand, the FB system can expect large attenuation, but is disadvantageous in terms of system stability as compared with the FF system.

### 2-3. IMC Noise Canceling System

In addition to a control system described with reference to FIGS. 1A to 1C (for convenience, it is referred to as a basic closed loop control (BCC) system), a control system using an internal model is also known in the FB noise canceling system. The FB noise canceling system using the internal model for control is referred to as an internal model control (IMC) system.

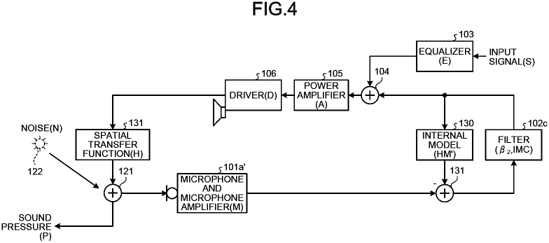

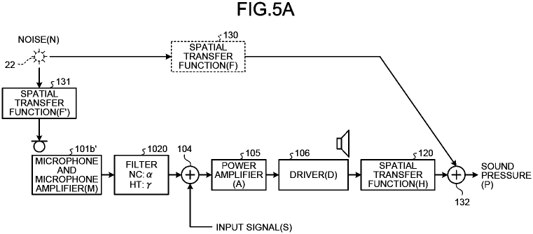

FIG. 4 is a diagram in which the FB noise canceling system using IMC is defined by transfer functions. Note that, in the FB noise canceling system using IMC, the configuration of the headphone 10_{FB} described with reference to FIG. 1B can be applied as it is.

In FIG. 4, similarly to FIG. 1C, the driver unit 106 is referred to as the driver 106. As illustrated in parentheses after each block name, the transfer function of the microphone and microphone amplifier 101a′ that integrates the microphone 100a and the microphone amplifier 101a is denoted by “M”, the transfer function of the power amplifier is denoted by “A”, the transfer function of the driver 106 is denoted by “D”, and the transfer function of the equalizer 103 is denoted by “E”. Furthermore, a spatial transfer function 120 is a transfer function from the driver 106 to the microphone 100a, and is denoted by “H”.

In FIG. 4, a transfer function of a filter 102c is denoted by an IMC transfer function “β₂”, and is distinguished from the transfer function “-β” of the filter 102a in FIG. 1C. Furthermore, an internal model 130 is a model for a space from the microphone 100a including, for example, an ear canal, and is denoted by a transfer function “HM′”. It is assumed that each transfer function is expressed by complex representation.

As can be seen from FIG. 4, in the FB noise canceling system using IMC, a signal component transmitted by the transfer function “β₂” of the filter 102c is applied to the transfer function “HM′” of the internal model 130, and the adder 131 subtracts the output of the internal model 130 from the signal component transmitted by the microphone and microphone amplifier 101a′ in the FB noise canceling system described with reference to FIGS. 1A to 1C. In the adder 131, the result of the internal model 130 is subtracted from the signal component transmitted by the microphone and microphone amplifier 101a′, and then the signal component is applied as an input to the filter 102c. A relationship between the blocks in FIG. 4 can be expressed by Expression (8) below using the transfer functions.

$$\text{P} = \frac{\left(1 + {β}_{2} \text{HM′}\right)}{1 + {β}_{2} \left(\text{HM′} - \text{DHM}\right)} \text{N}$$

### 2-4. External Sound Capturing Method

Next, the above-described ambient sound monitor will be detailed. In the sound output apparatus used by being worn on the ear or the head, such as the earphone or the headphone having the FF noise canceling function, instead of canceling the sound collected by the microphone 100b, it is also possible to provide a function of the ambient sound monitor for the purpose of listening to an external sound, i.e., ambient sound outside the housing, using the microphone 100b for collecting external sound installed an outer side of the housing.

For example, an ambient sound monitoring function is realized by setting the filter 102b for FF noise cancellation “not to cancel the sound signal”. Note that the method of realizing the ambient sound monitoring function is not limited thereto. For example, it can be realized by adding the external sound in parallel while keeping a FF noise canceling path. Hereinafter, an example of realizing the ambient sound monitoring function using a filter that does not cancel the sound signal of the sound collected by the microphone 100b will be described.

How much ambient sound is captured can be set as appropriate. Here, as a method of capturing the external sound as naturally as possible, an example of a hear through (HT) state will be described. Here, the hear through (hereinafter abbreviated as HT) state refers to a state in which the listener feels ambient environmental sound same as in a state of not wearing the earphone or the headphone even when the listener is wearing the earphone or the headphone. The HT state ideally represents a state in which the listener forgets that he or she is wearing the earphone or the headphone.

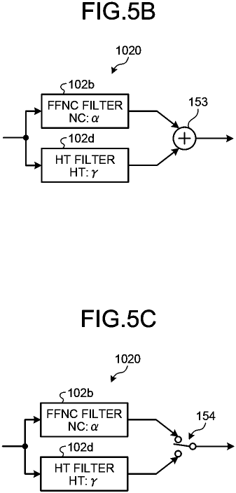

Here, a system that realizes the HT state will be described in comparison with the headphone applying the FF noise canceling system that has a similar configuration. FIGS. 5A to 5C are diagrams illustrating examples of a configuration of a system capable of realizing the HT function (hereinafter referred to as an HT system). FIG. 5A is a diagram defining the HT system by transfer functions. FIGS. 5B and 5C are diagrams illustrating examples of a configuration of a filter 1020 in FIG. 5A.

Note that, in the HT system, the electric circuit and the headphone in the configuration of the FF noise canceling system described with reference to FIG. 3A can be applied substantially as they are, and thus the description thereof will be omitted here.

In the HT system, a signal processing unit inserted between the microphone 100b for collecting external sound and the power amplifier 105 and the driver 106 inside the system is an HT filter, and its transfer function is “γ”.

In this case, as illustrated in FIG. 5A, the filter 1020 as a signal processing unit inserted between the microphone and microphone amplifier 101b′ and the driver 106 (and the adder 104 and the power amplifier 105) is common to the filter 102b having the transfer function “-α” (in FIG. 5A, a sign is inverted and indicated as “α”) in the FF noise canceling system. In other words, a difference between the filter 1020 in the HT system and the filter 102b in the FF noise canceling system is only a content of the filter.

Note that, in the example in FIG. 5A, as illustrated in FIGS. 5B and 5C2, the filter 1020 is illustrated as a configuration including the filter 102b in the FF noise canceling system having the transfer function “α” and a filter 102d for realizing the HT function having the transfer function “γ”.

In FIGS. 5B and 5C, the filter 102b is indicated as an “FFNC filter 102b”, and the filter 102d is indicated as an “HT filter 102d”. Hereinafter, in order to clarify a difference between functions of the filter 102b and the filter 102d, the filter 102b will be referred to as the FFNC filter 102b and the filter 102d will be referred to as the HT filter 102d as appropriate in the description.

In the example in FIG. 5B, an output of the FFNC filter 102b and an output of the HT filter 102d are added at a predetermined ratio by an adder 153 and output. In the example in FIG. 5C, the output of the FFNC filter 102b and the output of the HT filter 102d are switched by a switch 154. Note that functions of the adder 153 and the switch 154 can be realized, for example, by controlling filter coefficients. When it is desired to realize only the HT function, the filter 1020 may include only the HT filter 102d. Note that an addition ratio in the adder 153 and switching by the switch 154 can be controlled, for example, according to an instruction corresponding to a user operation.

Here, the FFNC filter 102b aims to design the transfer function “α” that satisfies Expression (9) below as described using Expressions (5) to (7).

$$\text{F′AHM} α \text{N} + \text{FN} \approx \text{0}$$

On the other hand, as described above, the HT function aims to realize the state in which the listener feels the ambient environmental sound same as when the listener does not wear the earphone or the headphone even when the listener wears the earphone or the headphone.

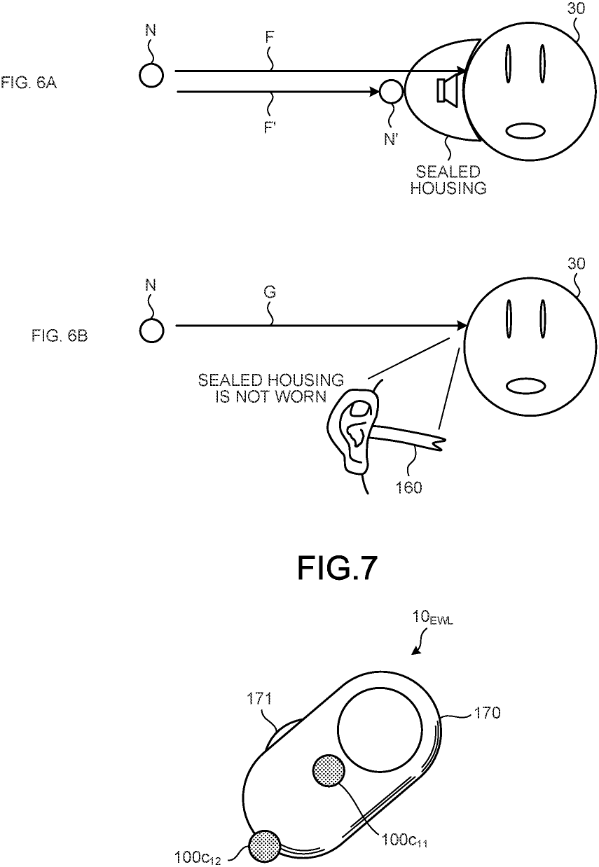

FIG. 6 is a schematic diagram illustrating a comparison between the FF noise canceling system and the HT system. In FIG. 6, section (a) schematically illustrates the FF noise canceling system. In the FF noise canceling system, a sealed housing spatially separates outside and the front surface (sound output surface) of the driver unit 106. Some kind of filtering process (e.g., FFNC filter 102b) is performed on external sound (referred to as “N”) collected by a microphone (not illustrated) for the FF noise canceling system installed outward on the sealed housing, and output from the driver unit 106. The sound output from the driver unit 106 and sound (referred to as “N′”) that is the external sound “N” leaked through the sealed housing are added in a space.

As illustrated in section (b) of FIG. 6, the HT filter 102d is designed to achieve acoustic conditions same as when the sealed housing is not worn at a position of an ear canal 160 on the head 30 of the listener. As an example, a transfer function “G” of the HT filter 102d is obtained based on acoustic measurement. The transfer function “G” indicates a transfer function from a sound source to the ear canal 107 when the headphone or earphone, which is the sealed housing, is not worn. The HT filter 102d aims to design the transfer function “γ” that satisfies Expression (10) below with respect to the transfer function “G”.

$$\text{F′AHM} γ \text{N} + \text{FN} \approx \text{GN}$$

Note that, since the sound output from the driver unit 106 is added to the external sound “N” leaking through the sealed housing at a sound speed, it is necessary to implement a low delay (e.g., 100 [µs] or less).

In addition, the FF noise canceling system, the HT system, and the FB noise canceling system (BCC or IMC) described above can be appropriately combined for use.

### 2-5. Number of Microphones

Next, the number of microphones for the FF noise canceling system mounted on the sound output apparatus (earphone or headphone) applicable to the embodiment will be described. In the noise cancelling and ambient sound monitoring functions described above, the microphone 100b for the FF noise canceling system is provided outward on the housing of each of the left and right earphones or headphones.

However, the earphone and the headphone are not limited thereto, and two or more microphones can be provided outward on the housing of at least one of the left and right earphones or headphones. Hereinafter, a case where two or more microphones are provided on each of the left and right earphones or headphones will be described.

FIG. 7 is a schematic diagram illustrating an appearance example of a so-called true wireless earphone 10_{EWL} in which a first housing including the driver unit 106 on the left side and a second housing including the driver unit 106 on the right side are independent, and sound signals are transmitted by communication between the first housing and the second housing. FIG. 7 illustrates one of the first and second housings, for example, a first housing 170. Since the other second housing has the same structure as the first housing, the description thereof will be omitted here.

In the example in FIG. 7, the first housing 170 is provided with two microphones 100_{C11} and 100_{C12} on a rear surface opposite to a sound output port 171. The second housing may be provided with two microphones, similarly, only one microphone, or three or more microphones.

As an example, the earphone 10_{EWL} is used in combination with a multifunctional mobile phone terminal (smartphone) or the like, and microphones 100_{C11} and 100_{C12} provided in the earphone 10_{EWL} are used for a call.

In this case, for example, similarly to the microphone 100b described above, the microphone 100_{C11} is mainly used for external sound collection by the FF noise canceling system, and can perform beamforming toward a mouth of the listener for voice transmission by using output signals of the microphones 100_{C11} and 100_{C12} together. Furthermore, it is also conceivable to use the microphones 100_{C11} and 100_{C12} to collect sound in a direction opposite to the mouth (ambient noise unnecessary for a call) and to cancel noise at the time of voice transmission according to a component of the sound collected. Naturally, noise cancellation by the above-described FF noise canceling system may be performed using both the microphones 100_{C11} and 100_{C12}.

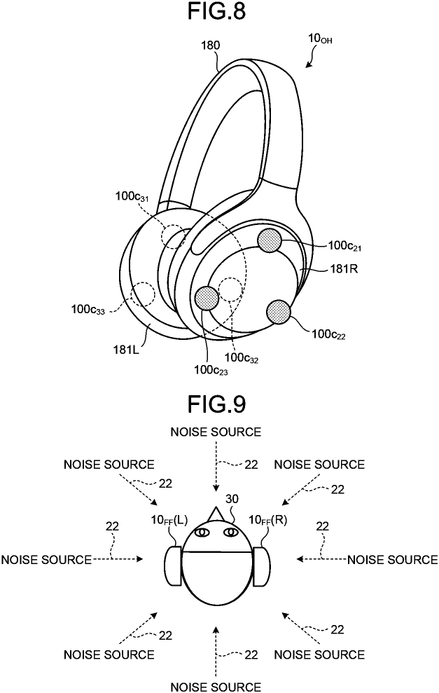

FIG. 8 is a schematic diagram illustrating an appearance example of an over-ear type headphone. In FIG. 8, a headphone 10_{OH} is configured such that a housing 181L including the driver unit 106 on the left side and a housing 181R including the driver unit 106 on the right side are connected by a headband 180. In the example in FIG. 8, three microphones 100_{C21}, 100_{C22}, and 100_{C23} are provided in the housing 181R. Similarly, three microphones 100_{C31}, 100_{C32} and 100_{C33} are also provided in the housing 181L. In this manner, by providing two or more microphones in one of the left and right housings, it is possible to improve a voice transmission quality at the time of a call.

Here, in the earphone or the headphone having the noise canceling function, there is a problem in the FF noise cancellation using the microphone provided one each in the left and right housings. For example, as described above, it is difficult to configure a filter having the transfer function that completely satisfies aforementioned Expression (6). In this case, one problem is that the characteristic in Expression (6) changes depending on an incoming direction of the external sound as a frequency of the external sound increases. In other words, the higher the frequency of the external sound is, the higher the dependency of the effect of the FF noise canceling system on the incoming direction.

Here, direction dependency of the effect of the FF noise canceling system will be described. The description will be given using an example that the headphone 10_{FF} is provided with one microphone 100b for the FF noise canceling system outward on each of the left (L side) and right (R side) housings with reference to FIG. 3B.

FIG. 9 is a schematic diagram illustrating incoming directions of the noise 22 when the headphone 10_{FF} is worn on the head 30 of the listener. On the head 30 of the listener, a left housing (L side) and a right housing (R side) of the headphone 10_{FF} are worn on the left ear and the right ear, respectively. The external sound comes from an entire circumference (360°) of the head 30 as noise 22 with respect to the sound output by the L side housing and the R side housing of the headphone 10_{FF}.

Among the transfer functions illustrated in FIG. 3C, the transfer functions are “F” of the spatial transfer function 130 and “F′” of the spatial transfer function 131 depending on the position of the noise source (incoming direction of the noise 22). The incoming direction of the noise 22 is represented by “θ″, and values obtained by considering the incoming direction of the noise 22 in the spatial transfer functions 130 and 131 are” F_{θ}″ and “F′_{θ}”, respectively. In this case, when Expression (6) described above is transformed in consideration of the influence of the incoming direction of the noise 22, Expression (11) is obtained, and it can be seen that “α_{θ}” that is the transfer function of the filter 102b depends on the incoming direction of the noise 22.

$${α}_{θ} = \frac{{\text{F}}_{θ}}{{\text{F′}}_{θ} \text{ADHM}}$$

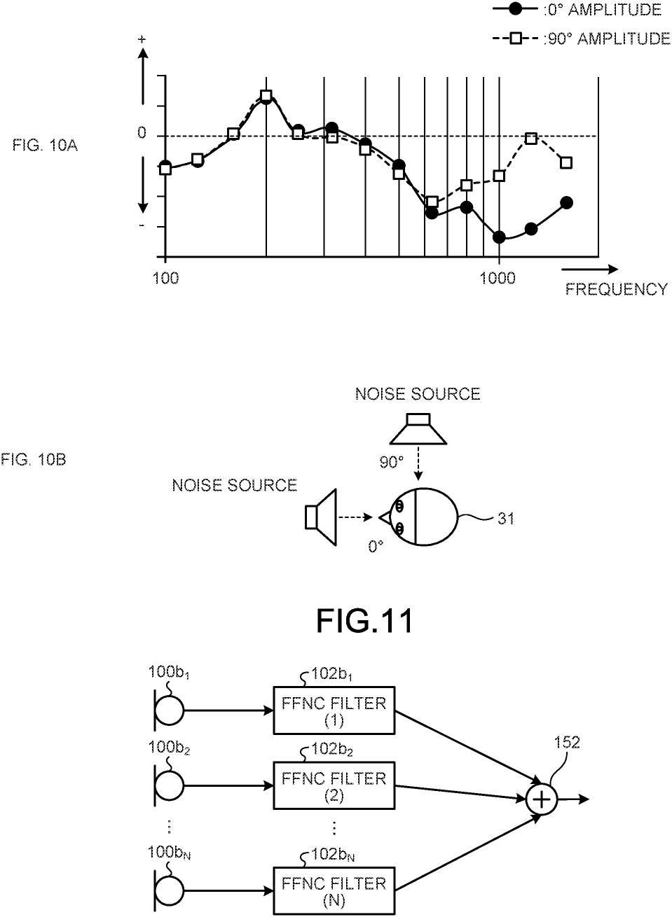

Here, a direction dependency of the transfer function “α_{θ}” of the filter 102b will be described. FIG. 10 is a diagram illustrating an example of amplitude characteristics of the transfer function “α” with respect to the noise 22 coming from different directions. In section (a) of FIG. 10, a horizontal axis represents a frequency, and a vertical axis represents an amplitude of the transfer function “α”. Furthermore, section (b) of FIG. 10 illustrates a definition of an angle representing the incoming direction of the noise 22. A front direction of a face of the listener 33 is defined as 0°, and the left side is defined as 90°. In section (a) of FIG. 10, a solid line and a plot of “• (black circle)” indicate amplitudes of the transfer function “α” in a 0° direction, and a dotted line and a plot of “□ (white square)” indicate amplitudes of the transfer function “α” in a 90° direction.

As the frequency increases, the characteristics of the filter 102b necessary for canceling the noise 22 are different for each incoming direction of the noise 22. In the example in section (a) of FIG. 10, the difference in characteristics is remarkable in a frequency band higher than 800 [Hz]. Therefore, in the microphone 100b for the FF noise canceling system on each of the left and right housings and one corresponding filter 102b, the cancellation performance for canceling the noise 22 is dependent on direction, and there is a possibility that sufficient cancellation performance cannot be obtained.

In order to solve this problem, it is considered to increase a degree of freedom of the FF noise canceling system. Even when one microphone 100b for the FF noise canceling system is used and a plurality of filters 102b are provided in parallel, the degree of freedom does not increase. Therefore, it is conceivable to increase the number of microphones 100b to two or more and the filter 102b is applied to each of the microphones 100b. In this case, for example, as illustrated in FIG. 8, three microphones 100_{C21}, 100_{C22}, and 100_{C23}, and microphones 100_{C31}, 100_{C32}, and 100_{C33} may be provided on the left and right, respectively, or more number of microphones may be provided.

FIG. 11 is a diagram illustrating an example of a configuration of the filter 102b when N microphones 100b are provided in the earphone or the headphone. In FIG. 11, N filters 100b₁, 100b₂,..., and 100b_{N} are provided, on one-on-one basis, in N microphones 102b₁, 102b₂,..., and 102b_{N} provided in the earphone or the headphone. Outputs of the filters 102b₁, 102b₂,..., and 102b_{N} are added by an adder 152 and output as one signal.

In this configuration, by setting characteristics of the filters 102b₁, 102b₂,..., and 102b_{N} according to each corresponding microphones 100b₁, 100b₂,..., and 100b_{N}, it is possible to reduce the direction dependency of the noise canceling performance in the FF noise canceling system.

In addition, the ambient sound monitor including the HT system similarly has the direction dependency, and this direction dependency can be reduced by using a plurality of microphones directed outward of the housing.

### <3. Embodiments>

Next, embodiments of the present disclosure will be described.

### 3-1. Known Problems in Conventional Technology

Prior to describing the embodiments of the present disclosure, known problems in the above-described conventional technology will be described. More specifically, in the above-described FF noise canceling system, a wind noise generated when wind hits the microphone for the FF noise canceling system provided in the housing of the earphone or the headphone becomes a problem. This problem similarly occurs in an ambient sound monitoring system that realizes the ambient sound monitoring function.

More specifically, in recent years, noise canceling performance has been improved in earphones or headphones supporting a digital noise canceling function. As one of the factors contributing to the improvement of the noise canceling performance is a position of a microphone for the FF noise canceling system provided outward on a housing of the earphone or the headphone.

When only the improvement of the noise canceling performance is considered, the microphone is supposed to be arranged at a position giving importance to the performance. On the other hand, there is a possibility that the wind noise is likely to occur depending on the position where the microphone is provided. The wind noise is generated when the wind hits the microphone. For example, it is considered that the wind noise is likely to occur by air-conditioning wind from a ceiling in a train or a bus, wind around a building (building wind), wind at a building entrance or entrance to a subway station from the ground, and windy open air. This wind noise may give discomfort to the listener, and it has been difficult to achieve both noise canceling performance and wind noise countermeasures.

In addition, the earphone or the headphone supporting the noise canceling function is often equipped with the ambient sound monitoring function that actively captures the ambient sound. Wind noise is also a problem in this function.

Furthermore, as described above, by providing the plurality of microphones for the FF noise canceling system in the housing of the earphone or the headphone, performance of the noise canceling function and the ambient sound monitoring function is improved. However, the wind noise is random noise and there is no correlation in the wind noise generated at each position of the microphones. The larger the number of microphones is, the more susceptible to the wind noise.

On the other hand, conventionally, a microphone position and a mounting structure that achieve improvement in both noise canceling performance and wind noise reduction have been studied typically using fluid simulation. However, it is considered that the time during which the microphone provided in the earphone or the headphone is exposed to the wind is extremely short with respect to the entire use time during which the listener uses the earphone or the headphone. Therefore, if it is possible to detect the wind noise and automatically and temporarily stop the use of the microphone provided outward on the housing or reduce the number of microphones used, the microphones may be arranged at positions giving the highest priority to the noise canceling performance.

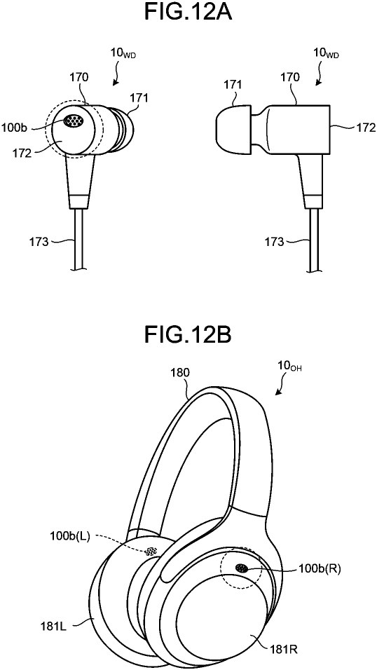

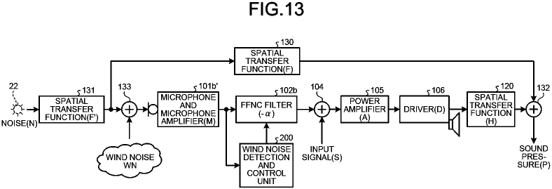

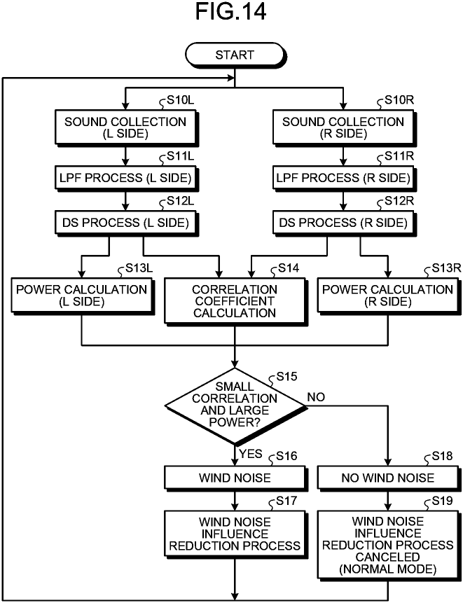

Generation of the wind noise will be detailed with reference to FIGS. 12A, 12B, FIG. 14. FIGS. 12A and 12B are diagrams illustrating an assumed position of the microphone.

FIG. 12A is a diagram corresponding to FIG. 9 described above, and illustrates an example of the position of the microphone 100b arranged in an earphone 10_{WD}. A right diagram is schematic view seen from a side surface side, and a left diagram is a schematic view seen from a rear surface side. In this example, as surrounded by a dotted line in the left diagram, the microphone 100b for the FF noise canceling system (or for the ambient sound monitoring system) is provided outward on a rear surface 172. In FIG. 12A, one earphone 10_{WD} of the a pair of left and right earphones 10_{WD} is illustrated, but similarly, the microphone 100b is provided outward on the rear surface 172 of the other earphone 10_{WD}.

For example, FIG. 12B corresponds to FIG. 8 described above, and illustrates an example of the position of the microphone 100b arranged in the headphone 100_{OH}. In an example in FIG. 12B, microphones 100b(L) and 100b(R) are respectively provided outward on the left housing 181L and the right housing 181R connected by the headband 180.

Sound collected by the microphone 100b for the FF noise canceling system (or for the ambient sound monitoring system) is affected by wind hitting the head 30 of the listener. In other words, when the wind hits the head 30 of the listener, turbulence occurs due to an influence of the housing of the headphone 10_{OH} or the earphone 10_{WD}, the head 30, the auricle, and the like. For example, when the wind hits these parts, a direction of the wind changes complicatedly, and a turbulent flow is generated.

This turbulent air flow acts on the diaphragm of the microphone 100b provided outward in the housing of the headphone 10_{OH} or the earphone 10_{WD}, thereby generating wind noise. In daily life, such turbulence around the headphone 10_{OH} or the earphone 10_{WD} often occurs by air conditioning in a train or a bus, at an entrance from the ground to a building or a subway station, and the like as described above.

In the FF noise canceling system, when the sound (noise) to be canceled is “N”, a sound output after performing the filter process using the filter (e.g., filter 102b) on noise “N” collected by the microphone 100b is superimposed, in an opposite phase at an eardrum point, on sound reaching an eardrum through, for example, the ear pad of the headphone 10_{OH} or the housing 170 of the earphone 10_{WD}. As a result, the noise “N” is canceled at the eardrum point. In the ambient sound monitoring system, operation is performed to reproduce the same sound pressure, at the eardrum point, as when the headphone 10_{OH} or the earphones 10_{WD} is not worn.

### 4. First Embodiment

Next, a first embodiment of the present disclosure will be described. FIG. 13 is a diagram illustrating an example of a configuration of an FF noise canceling system in consideration of wind noise (hereinafter referred to as wind noise WN.) according to the first embodiment. The configuration illustrated in FIG. 13 is a configuration in which the wind noise WN and a wind noise detection and control unit 200 that detects the wind noise WN and performs control according to a detection result are added to the configuration of the FF noise canceling system in FIG. 3C described above.

Note that, as described with reference to FIG. 5A, the FF noise canceling system can also be applied to the ambient sound monitoring system by changing the content of the filter 102b. Hereinafter, an example in which the first embodiment is applied to the FF noise canceling system will be mainly described. Furthermore, in the following description, as a sound output apparatus, the headphone will be described as an example in the earphone and the headphone.

The wind noise WN is considered in the FF noise canceling system. In the example in FIG. 13, the noise 22 reaching a surface of the housing of the headphone by the spatial transfer function 131 leaks inside the housing of the headphone and is transmitted to inside of the headphone by the spatial transfer function 130. At the same time, the noise 22 is added to the wind noise WN generated at the position of the microphone 100b (not illustrated) in a space (illustrated as an adder 133) and collected by the microphone 100b (microphone and microphone amplifier 101b′).

In this manner, the wind noise WN is generated at the position of the microphone 100b and added to the noise 22. Therefore, the wind noise WN does not reach the eardrum point via the ear pad. In addition, since the wind does not directly reach the ear due to the housing of the headphone, a wind noise different from the wind noise WN will not occur in the ear. Accordingly, in the FF noise canceling system, since there is no object to be superimposed and canceled in the opposite phase with respect to the wind noise WN, the listener hears the wind noise and may feel discomfort.

In addition, also in the ambient sound monitoring system, the listener hears the wind noise WN due to the same reason.

The wind noise detection and control unit 200 detects whether or not a component of the wind noise WN is included in a sound signal output from the microphone and microphone amplifier 101b′, and controls the FFNC filter 102b according to a detection result.

A detection process of the wind noise WN in the wind noise detection and control unit 200 will be described more specifically. It is assumed that the microphone 100b for the FF noise canceling system is provided, for example, in each of the left and right headphones. As described above, since the wind noise WN is generated due to the turbulence and is random, there is no correlation between signals of the microphones 100b.

On the other hand, a low-frequency sound of the ambient sound when there is no wind has a wavelength of 3.4 [m] when the frequency is, for example, 100 [Hz], and is sufficiently long with respect to a distance between the microphones. For example, when the microphone 100b is provided on each of the left and right headphones, a diameter is about 20 to 30 [cm]. Furthermore, when a plurality of microphones 100b is provided on one, i.e., left or right of the headphones, a distance between the plurality of microphones 100b is, for example, within 10 [cm]. Therefore, the low-frequency sound of the ambient sound is substantially in the same phase in two microphones 100b, and correlation becomes high.

The wind noise detection and control unit 200 calculates the correlation between sound signals of sound collected by the plurality of microphones 100b provided on the left and right headphones or one of the headphones, and determines that wind is blowing when the correlation is equal to or less than a predetermined value.

FIG. 14 is a flowchart illustrating an example of a wind noise detection process according to the first embodiment. Note that, in FIG. 14, a process in Steps S10L to S13L indicates a process related to the output of the microphone 100b provided on the left side (left channel: Lch) of the headphone, and a process in Steps S10R to S13R indicates a process related to the output of the microphone 100b provided on the right side (right channel: Rch) of the headphone. The process in Steps S10L to S13L and the process in Steps S10R to S13R are executed in parallel timewise.

In Step S10L, sound is collected by the microphone 100b of the left channel (L side), and a sound signal based on the sound collected is output from the microphone 100b and supplied to the wind noise detection and control unit 200. Note that the wind noise detection and control unit 200 converts this sound signal into a digital sound signal having a sampling frequency of 48,000 [Hz], for example. The sampling frequency at this point is not limited to 48,000 [kHz], and may be another frequency.

In next Step S11L, the wind noise detection and control unit 200 performs a low-pass filter process on the sound signal supplied from the microphone 100b in Step S10L, passes a low-frequency component having a frequency of, for example, 100 [Hz] or less to cut off medium and high frequency components. A cutoff frequency of the low-pass filter process is not limited thereto, and is, for example, a frequency within a range from 20 [Hz] to 500 [Hz].

In next Step S12L, the wind noise detection and control unit 200 performs a down-sampling process on the sound signal subjected to the low-pass filter process in Step S11L. Here, for example, the sampling frequency of 48,000 [Hz] is down-sampled to several 100 s [Hz] in the down-sampling process.

In next Step S13L, the wind noise detection and control unit 200 calculates wind power based on the sound signal down-sampled in Step S12L. For example, the wind noise detection and control unit 200 can integrate an absolute signal value in a predetermined time range of the sound signal and use this integrated value as a value indicating the wind power.

A process related to the output of the microphone 100b of the right channel is similar to the process of the left channel in Steps S10L to S13L. In other words in Step S10R, sound is collected by the microphone 100b of the right channel, and a sound signal based on the collected sound is supplied to the wind noise detection and control unit 200. In next Step S11R, the wind noise detection and control unit 200 performs the low-pass filter process on the sound signal supplied from the microphone 100b in Step S10R, and performs the down-sampling process on the sound signal subjected to the low-pass filter process in next Step S12R. In next Step S13R, the wind noise detection and control unit 200 calculates the wind power based on the sound signal down-sampled in Step S12R.

In Step S14, the wind noise detection and control unit 200 calculates a correlation coefficient between a left-channel sound signal down-sampled in Step S12L and a right-channel sound signal down-sampled in Step S12R. At this point, the wind noise detection and control unit 200 preferably calculates an absolute value of the correlation coefficient in consideration of negative correlation.

In Step S15, the wind noise detection and control unit 200 determines whether or not wind equal to or more than a predetermined level is blowing to the headphone based on a power value of the left channel calculated in Step S13L, a power value of the right channel calculated in Step S13R, and the correlation coefficient calculated in Step S14. In other words, in Step S15, the wind noise detection and control unit 200 determines the presence or absence of the influence of wind noise on the FF noise canceling system.

The wind noise detection and control unit 200 sets, for example, a first threshold for the correlation coefficient and a second threshold for the power value. When the correlation coefficient calculated in Step S14 is less than the first threshold and at least one of the power value calculated in Step S13L and the power value calculated in Step S13R is equal to or more than the second threshold (Step S15, “Yes”), the wind noise detection and control unit 200 determines that the wind equal to or more than the predetermined level is blowing to the headphone. In other words, the wind noise detection and control unit 200 determines that there is an influence of wind noise on the FF noise canceling system (Step S16).

After the determination in Step S16, the process proceeds to Step S17. In Step S17, the wind noise detection and control unit 200 executes a process of reducing the influence of wind noise on the FF noise canceling system. This reduction process will be described later. After executing the process in Step S17, the wind noise detection and control unit 200 returns the process to the start of the flowchart, which is Steps S10L and S10R.

On the other hand, in Step S15, when the correlation coefficient calculated in Step S14 is equal to or more than the second threshold, or each of the power value calculated in Step S13L and the power value calculated in Step S13R is less than the second threshold (Step S15, “No”), the wind noise detection and control unit 200 determines that the wind equal to or more than the predetermined level is not blowing to the headphone. In other words, the wind noise detection and control unit 200 determines that there is no influence of wind noise on the FF noise canceling system (Step S18).

When it is determined in Step S18 that there is no influence of wind noise on the FF noise canceling system, the process proceeds to Step S19. In Step S19, the wind noise detection and control unit 200 cancels the reduction process (described later) for the influence of the wind noise. For example, when the reduction process for the influence of the wind noise has been executed in Step S17 described above before Step S19 is executed, the wind noise detection and control unit 200 cancels the reduction process. By canceling the reduction process for the influence of the wind noise, a noise removal processing by the FF noise canceling system is returned to a normal state in which wind is not considered (normal mode). After executing a process in Step S19, the wind noise detection and control unit 200 returns the process to the start of the flowchart, which is Steps S10L and S10R.

In each process described above, the low-pass filter process in Steps S11L and S11R can be omitted. This is because high-frequency ambient sounds have low correlation between the left and right channels.

In addition, the down-sampling process in Steps S12L and S12R can also be omitted. However, down-sampling is preferable because the number of product-sum operations on calculating the correlation coefficient in Step S15 and a memory size required for a buffer can be saved.

Furthermore, when the calculation of the correlation coefficient is performed in any one of the left and right channels in a true wireless earphone in which the housings of the left and right channels are independent and communication is performed between the housings, it is preferable to execute the down-sampling process because a data communication amount when data for the calculation is communicated between the left and right channels can be reduced.

Furthermore, in the above description, for example, a band-limiting filter for power calculation in Step S13L and a band-limiting filter for correlation coefficient calculation in Step S14 are shared in the left channel, but the configuration is not limited thereto. For example, the band-limiting filter for power calculation in Step S13L and the band-limiting filter for correlation coefficient calculation in Step S14 may be configured by individual band-limiting filters.

In the above description, the presence or absence of wind noise is determined based on the wind power obtained based on the sound collected by the microphones 100b of the left and right channels and the correlation coefficient, but the determination is not limited thereto. For example, it is also possible to determine the presence or absence of wind noise using artificial intelligence. More specifically, the artificial intelligence can be configured such that each sound signal of the sound collected by each of the microphones 100b of the left and right channels is used as an input, and the presence or absence of wind noise is determined based on each sound signal input.

As an example, a neural network in which machine learning is performed using an arbitrary sound signal including wind noise as learning data and the presence or absence of wind noise as answer data is prepared. The sound signal based on the sound collected by the microphones 100b of the left and right channels or a plurality of channels is input to a neural network. The neural network determines the presence or absence of wind noise based on the sound signal input. Note that the input to the artificial intelligence is not limited thereto, and data obtained by performing the low-pass filter process or the down-sampling process on each sound signal may be applied.

In addition, it is also possible to determine the presence or absence of wind noise based on a spectrum in a frequency domain obtained by converting the sound signal of the sound collected by the microphones 100b of the left and right channels or a plurality of channels into a frequency domain by fast Fourier transform (FFT).

Furthermore, it is conceivable that a degree of wind noise that the listener feels changes according to a volume (level) of the input signal as the sound source signal. Therefore, it is also possible to change the threshold for determining the presence or absence of wind noise in consideration of the volume (level) of the sound source signal and the above-described spectrum.

### 4-1. Configuration Example of First Embodiment

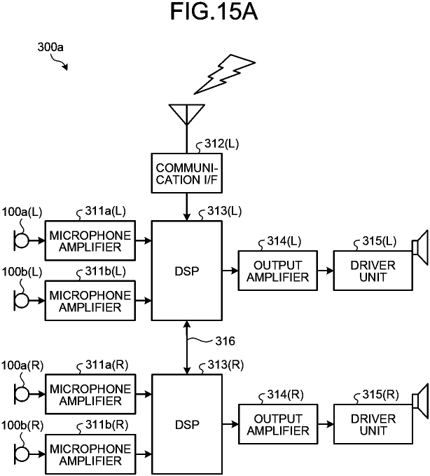

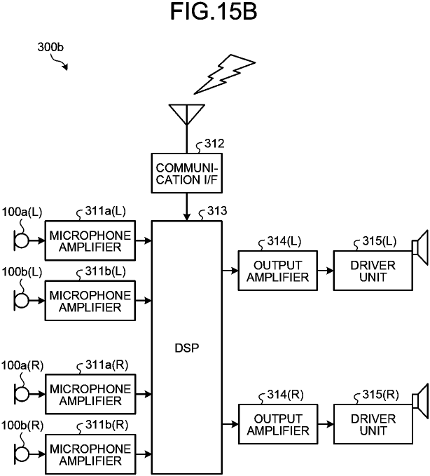

Next, a configuration example of the first embodiment will be described more specifically. FIG. 15A is a hardware block diagram of an example of a sound output apparatus including the signal processing device according to the first embodiment. A sound output apparatus 300a illustrated in FIG. 15A includes microphones 100a(L) and 100a(R) for a FB noise canceling system and microphones 100b(L) and 100b(R) for the FF noise canceling system in each of the left and right channels.

In the example in FIG. 15A, the left and right channels include corresponding components. The left channel includes microphone amplifiers 311a(L) and 311b(L), a digital signal processor (DSP) 313(L), an output amplifier 314(L), and a driver unit 315(L). The right channel includes microphone amplifiers 311a(R) and 311b(R), DSP 313(R), output amplifier 314(R), and driver unit 315(R).

Among them, the microphone amplifiers 311a(L) and 311a(R) correspond to, for example, the microphone amplifier 101a in FIG. 1A, and the microphone amplifiers 311b(L) and 311b(R) correspond to, for example, the microphone amplifier 101b in FIG. 3A. The output amplifiers 314(L) and 314(R) correspond to the power amplifiers 105 in FIGS. 1A and 3A, respectively. Further, the driver units 315(L) and 315(R) correspond to the driver unit 106 in FIGS. 1A and 3A, respectively.

A communication I/F 312(L) supports communication by Bluetooth (registered trademark), for example, and communicates with external equipment. In the example in FIG. 15A, the communication I/F 312(L) is connected to the DSP 313(L), receives the sound source signal transmitted from the external equipment, and passes the sound source signal to the DSP 313(L). The communication I/F 312(L) can also receive a control signal including an instruction transmitted from the external equipment.

Each of the DSPs 313(L) and 313(R) includes the filter 102a and the equalizer 103 for implementing the FB noise canceling system described with reference to FIGS. 1A to 1C, and the FFNC filter 102b for implementing the FF noise canceling system described with reference to FIGS. 3A to 3C. The DSP 313(L) further includes the above-described wind noise detection and control unit 200.

The DSPs 313(L) and 313(R) include a memory area, and the signal processing in the sound output apparatus 300a is controlled according to a signal processing program stored in the memory area. For example, when the signal processing program is operated, the DSP 313(L) configures each of the filters 102a and 102b, the equalizer 103, and the wind noise detection and control unit 200 described above on a main storage area in the memory area, for example, as a module. Note that the signal processing program can be acquired from the outside via the communication I/F 312(L) to be described later and installed on the sound output apparatus 300a. The same applies to the DSP 313(R).

A communication path 316 connects the DSP 313(L) and the DSP 313(R). The communication path 316 may be a path for performing wired communication or a path for performing wireless communication. When the communication path 316 is a path for wireless communication, near field magnetic induction (NFMI) or Bluetooth (registered trademark) can be applied as a communication method. In the communication path 316, not only transmission of the sound signal but also transmission and reception of a predetermined control signal between the DSP 313(L) and the DSP 313(R) are performed.

First, a process in the right channel process will be described. In the right channel, an analog sound signal based on sound collected by the microphone 100a(R) is supplied to the microphone amplifier 311a(R), subjected to a predetermined signal process such as gain adjustment, sampled at a predetermined sampling frequency, converted into a digital sound signal, and output. The sound signal output from the microphone amplifier 311a(R) is supplied to the DSP 313(R).

Further, the analog sound signal based on sound collected by the microphone 100b(R) is supplied to the microphone amplifier 311b(R). The microphone amplifier 311b(R) samples the analog sound signal supplied from the microphone 100b at a predetermined sampling frequency, converts the signal into a digital sound signal, and outputs the digital sound signal. The sound signal output from the microphone amplifier 311b(R) is supplied to the DSP 313(R).

The DSP 313(R) performs processing by the FB system noise canceling system on the sound signal supplied from the microphone amplifier 311a using the filter 102a and the equalizer 103, and generates a signal for FB noise cancellation. The DSP 313(R) combines the signal for FB noise cancellation with the sound source signal and performs a FB noise cancellation process. As will be described later, the sound source signal is transmitted from the external equipment, received by the communication I/F 312(L), and supplied to the DSP 313(R) via the DSP 313(L).

The DSP 313(R) combines the signal for FB noise cancellation and the signal subjected to the FF noise cancellation process with the sound source signal and outputs a combined signal. The sound signal output from the DSP 313(R) is power-amplified by the output amplifier 314(R), supplied to the driver unit 315(R), and output as sound in the form of air vibration.

Furthermore, the DSP 313(R) includes the low-pass filter and the down-sampling unit, and performs the low-pass filtering process in Step S11(R) and the down-sampling process in Step S12(R) in the flowchart in FIG. 14 on the sound signal supplied from the microphone amplifier 311b(R). The sound signal subjected to the low-pass filter process and the down-sampling process in the DSP 313(R) is transmitted to the DSP 313(L) via the communication path 316.

Next, a process in the left channel will be described. Also in the left channel, similarly to the right channel, an analog sound signal based on sound collected by the microphone 100a(L) is supplied to the microphone amplifier 311a(L), subjected to the predetermined signal process such as gain adjustment, sampled at the predetermined sampling frequency, converted into the digital sound signal, and output. The sound signal output from the microphone amplifier 311a(L) is supplied to the DSP 313(L).

Furthermore, the analog sound signal based on the sound collected by the microphone 100b(L) is supplied to the microphone amplifier 311b(L), and the analog sound signal supplied from the microphone 100b is sampled at a predetermined sampling frequency, converted into a digital sound signal, and output. The sound signal output from the microphone amplifier 311b(L) is supplied to the DSP 313(L).

The DSP 313(L) performs a process by the FF system noise canceling system on the sound signal supplied from the microphone amplifier 311b using the filter 102b, and generates a signal for FF noise cancellation.

The DSP 313(L) combines the signal for FB noise cancellation and the signal subjected to the FF noise cancellation process with the sound source signal, and outputs a combined signal. The sound signal output from the DSP 313(L) is power-amplified by the output amplifier 314(L), supplied to the driver unit 315(L), and output as sound in the form of air vibration.

The DSP 313(L) includes the low-pass filter and the down-sampling unit, and performs the low-pass filter process in Step S11(L) and the down-sampling process in Step S12(L) in the flowchart in FIG. 14 on the sound signal supplied from the microphone amplifier 311b.

The sound signal subjected to the low-pass filter process and the down-sampling process is passed to the wind noise detection and control unit 200. The sound signal subjected to the low-pass filter process and the down-sampling process by the DSP 313(R) is also supplied to the wind noise detection and control unit 200. The wind noise detection and control unit 200 performs the wind noise detection process as described above based on these sound signals. The wind noise detection and control unit 200 controls the operation of the filter 102b of each of the DSPs 313(L) and 313(R) according to the detection result of the wind noise, and reduces the influence of wind noise on the noise canceling function.

Note that, in the above description, the sound output apparatus 300a has been described to have the left-channel DSP 313(L) and the right-channel DSP 313(R), but the configuration is not limited thereto. For example, as illustrated in a sound output apparatus 300b in FIG. 15B, one DSP 313 may be shared by the left channel and the right channel. The DSP 313 performs the signal processing described above on each of left-channel sound signals output from the microphone amplifiers 311a(L) and 311b(L) and right-channel sound signals output from the microphone amplifiers 311a(R) and 311b(R). The DSP 313 supplies the sound signal obtained by performing the signal processing on the left-channel sound signals output from the microphone amplifiers 311a(L) and 311b(L) to the output amplifier 314(L). Similarly, the DSP 313 supplies the sound signal obtained by performing the signal processing on the right-channel sound signals output from the microphone amplifiers 311a(R) and 311b(R) to the output amplifier 314(R). The communication I/F 312 that communicates with the external equipment is connected to the DSP 313.

### 41. Control According to Detection Result of Wind noise

Next, control according to a detection result of wind noise according to the first embodiment will be described. This control corresponds to the process in Step S17 of the flowchart in FIG. 14, and the wind noise detection and control unit 200 executes the process of reducing the influence of wind noise on the FF noise canceling system according to the detection result of the wind noise.

FIG. 16 is a block diagram of an example illustrating the control by the wind noise detection and control unit 200 according to the first embodiment. Note that, in FIG. 16 and subsequent similar drawings, for example, the microphone amplifiers 311a(L), 311b(L), 311a(R), and 311b(R) illustrated in FIG. 15 described above are omitted from the configuration. In FIG. 16, output devices 202(L) and 202(R) respectively correspond to, for example, the output amplifier 314(L) and the driver unit 315(L), and the output amplifier 314(R) and the driver unit 315(R) in FIG. 15.

In FIG. 16, the wind noise detection and control unit 200 includes a wind noise detection unit 2000 and a control unit 2010. The wind noise detection unit 2000 includes the low-pass filter and the down-sampling unit of the left and right channels, and executes the process in Step S11L and Steps S11R to S15 of the flowchart in FIG. 14. The control unit 2010 executes the process in Step S16 of the flowchart in FIG. 14.

More specifically, according to the detection result of the presence or absence of wind noise by the wind noise detection unit 2000, the control unit 2010 adjusts a degree of control of hearing (how the sound is heard) by the listener of the sound output from the output devices 202(L) and 202(R) between a degree of control when it is determined that the wind noise has been detected and a degree of control when it is determined that the wind noise has not been detected.

In other words, the wind noise detection and control unit 200 including the wind noise detection unit 2000 and the control unit 2010 functions as an adjustment unit that adjusts the degree of control of the hearing by the listener of the sounds output from the output devices 202(L) and 202(R) between the degree of control (degree for wind) when it is determined that the wind noise has been detected and the degree of control (degree for non-wind) when it is determined that the wind noise has not been detected.

In FIG. 16, an output level of an FFNC filter 102b(L) for the left channel is adjusted by a buffer amplifier 201(L) and supplied to the output device 202(L). Similarly, an output level of an FFNC filter 102b(R) for the right channel is adjusted by a buffer amplifier 201(R) and supplied to the output device 202(R).

Note that an addition unit 104a or 104b that combines sound source signals is inserted (not illustrated) between the buffer amplifier 201(L) and the output device 202(L) and between the buffer amplifier 201(R) and the output device 202(R), respectively.

The control unit 2010 controls the buffer amplifiers 201(L) and 201(R) according to the detection result of the wind noise detection unit 2000. More specifically, when the wind noise detection unit 2000 determines that there is no influence (influence less than a predetermined value) of the wind noise (Step S15, “No” in FIG. 14), the control unit 2010 controls the buffer amplifiers 201(R) and 201(L) to increase signal levels supplied from the FFNC filters 102b(L) and 102b(R) to the output devices 202(L) and 202(R). For example, the control unit 2010 controls the buffer amplifiers 201(R) and 201(L) so as to obtain the maximum noise cancellation effect. As a result, sound output from the output devices 202(L) and 202(R) will be sound that cancels the noise due to the external sound at the maximum.

On the other hand, when the wind noise detection unit 2000 determines that there is an influence (influence equal to or more than the predetermined value) of wind noise (Step S15, “Yes” in FIG. 14), the control unit 2010 controls the buffer amplifiers 201(R) and 201(L) to decrease signal levels supplied from the FFNC filters 102b(L) and 102b(R) to the output devices 202(L) and 202(R). For example, the control unit 2010 controls the output levels of the buffer amplifiers 201(R) and 201(L) to be zero. As a result, the degree of noise cancellation with respect to noise due to the external sound is reduced, and the influence of wind noise on the noise cancellation process is reduced.

Here, the FFNC filters 102b(L) and 102b(R) function as a control unit that controls hearing, by the listener, of the sound output from the output devices 202(L) and 202(R) according to the control of the wind noise detection and control unit 200 based on the sound signals output from the two microphones 100b(L) and 100b(R).

As described above, in the first embodiment, the presence or absence of wind noise is determined based on the sound signal output from the microphone 100b for the FF noise canceling system, and the degree of noise cancellation by the FF noise canceling system is controlled according to the determination result. Therefore, the influence of wind noise on the noise cancellation process can be reduced without increasing the number of microphones.

In addition, even when it is determined that the wind noise is generated and a noise cancellation capability of the FF noise canceling system is reduced, the noise cancellation process by the FB noise canceling system is executed as usual, and it is possible to obtain an effect of noise cancellation.

### 4-2. First Modification of First Embodiment

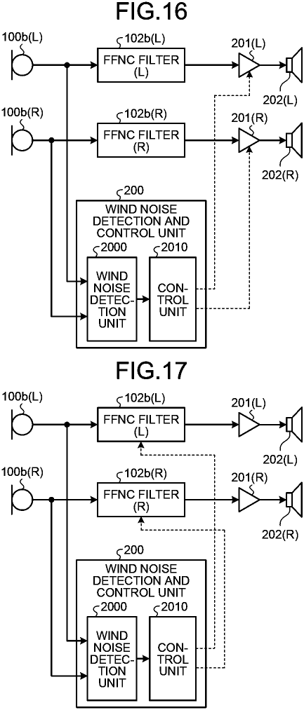

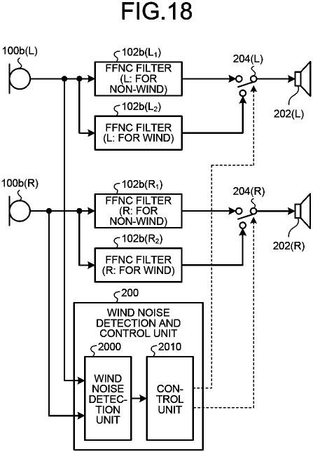

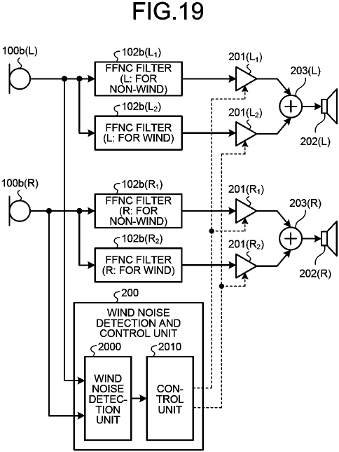

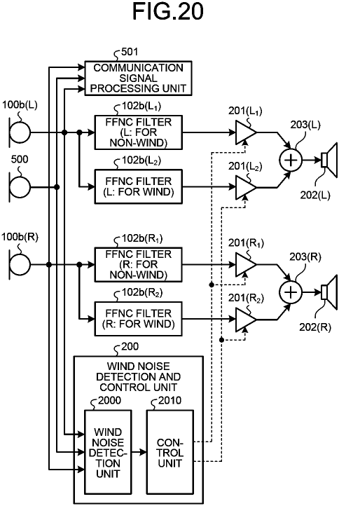

Next, a first modification of the first embodiment will be described. FIG. 17 is a block diagram of an example illustrating control by the wind noise detection and control unit 200 according to the first modification of the first embodiment.

In FIG. 17, outputs of the FFNC filters 102b(L) and 102b(R) are supplied to the output devices 202(L) and 202(R) via the buffer amplifiers 201(L) and 201(R), respectively. Note that an addition unit 104a or 104b that combines sound source signals is inserted (not illustrated) between the buffer amplifier 201(L) and the output device 202(L) and between the buffer amplifier 201(R) and the output device 202(R), respectively.

The control unit 2010 controls the FFNC filters 102b(L) and 102b(R) according to the detection result of the wind noise detection unit 2000. This control by the control unit 2010 is performed, for example, by controlling filter coefficients of the FFNC filters 102b(L) and 102b(R).

More specifically, when the wind noise detection unit 2000 determines that there is no influence (influence less than a predetermined value) of wind noise (Step S15, “No” in FIG. 14), the control unit 2010 controls the filter coefficients of the FFNC filters 102b(L) and 102b(R) to execute noise cancellation by the FF noise canceling system as usual. As a result, the sound output from each of the output devices 202(L) and 202(R) becomes a sound that cancels noise due to external sound.

On the other hand, when the wind noise detection unit 2000 determines that there is an influence (influence equal to or more than the predetermined value) of the wind noise (Step S15, “Yes” in FIG. 14), the control unit 2010 controls the filter coefficients of the FFNC filters 102b(L) and 102b(R) so as to reduce the degree of noise cancellation by the FF noise canceling system. For example, the control unit 2010 controls the filter coefficients of the FFNC filters 102b(L) and 102b(R) such that the outputs of the FFNC filters 102b(L) and 102b(R) become zero. As a result, the degree of noise cancellation with respect to noise due to the external sound is reduced, and the influence of wind noise on the noise cancellation process is reduced.

As described above, in the first modification of the first embodiment, the presence or absence of wind noise is determined based on the sound signal output from the microphone 100b for the FF noise canceling system, and the degree of noise cancellation by the FF noise canceling system is controlled according to the determination result. Therefore, the influence of wind noise on the noise cancellation process can be reduced without increasing the number of microphones.

In addition, even when it is determined that the wind noise is generated and a noise cancellation capability of the FF noise canceling system is reduced, the noise cancellation process by the FB noise canceling system is executed as usual, and it is possible to obtain an effect of noise cancellation.

### 4-3. Second Modification of First Embodiment

Next, a second modification of the first embodiment will be described. The second modification of the first embodiment is an example in which the FFNC filter 102b for wind and the FFNC filter 102b for non-wind are provided in each of the left and right channels.

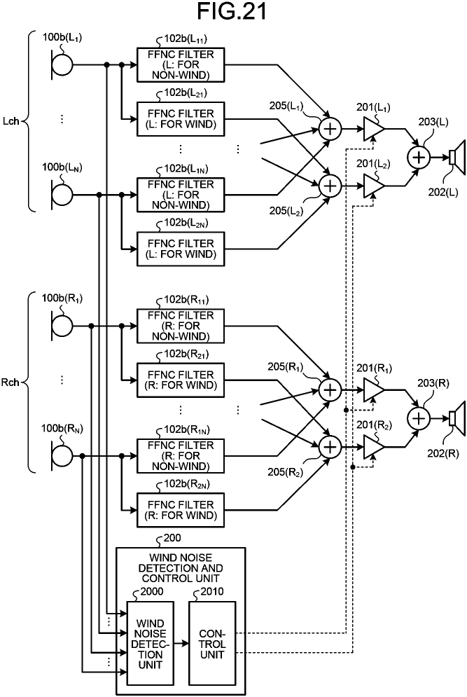

FIG. 18 is a block diagram of an example illustrating control by a wind noise detection and control unit according to the second modification of the first embodiment. In the left channel, the sound signal output from the microphone 100b(L) is supplied to an FFNC filter 102b(L₁) for non-wind and an FFNC filter 102(L₂) for wind, respectively. Outputs of the FFNC filters 102b (L₁) and 102b(L₂) are respectively supplied to a first input end and a second input end of a switch 204(L) whose switching is controlled by the control unit 2010. An output from an output end of the switch 204(L) is supplied to the output device 202(L).

Similarly in the right channel, the sound signal output from the microphone 100b(R) is supplied to an FFNC filter 102b(R₁) for non-wind and an FFNC filter 102(R₂) for wind. Outputs of the FFNC filters 102b(R₁) and 102b(R₂) are respectively supplied to a first input end and a second input end of a switch 204(R) whose switching is controlled by the control unit 2010. An output from an output end of the switch 204(R) is supplied to the output device 202(R).

Here, the FFNC filters 102b(L₁) and 102b(R₁) for non-wind have characteristics equivalent to those of the FFNC filters 102b(L) and 102b(R) in FIG. 16 described above, and correspond to, for example, the filter 102b having the transfer function “-α” described with reference to FIG. 3C. In other words, the FFNC filters 102b(L₁) and 102b(R₁) for non-wind have characteristics in which the wind noise is not taken into consideration.

On the other hand, the FFNC filters 102b(L₂) and 102b(R₂) for wind are filters having characteristics considering the wind noise as compared with the above-described FFNC filters 102b(L₁) and 102b(R₁) for non-wind. As an example, the FFNC filters 102b(L₂) and 102b(R₂) for wind have the characteristics in which the degree of noise cancellation is lower than that of the FFNC filters 102b(L₁) and 102b(R₁) or zero in a main frequency band of wind noise (e.g., a frequency band from 200 [Hz] to 100 [Hz] or less) with respect to the characteristics of the FFNC filters 102b(L₁) and 102b(R₁) for non-wind.

The control unit 2010 controls switching by the switches 204(L) and 204(R) according to the detection result of the wind noise detection unit 2000.

More specifically, when the wind noise detection unit 2000 determines that there is no influence (influence less than the predetermined value) of the wind noise (Step S15, “No” in FIG. 14), the control unit 2010 switches each of the switches 204(L) and 204(R) to the first input end and selects the FFNC filters 102b(L₁) and 102b(R₁) for non-wind. As a result, the sound output from each of the output devices 202(L) and 202(R) becomes a sound that cancels noise due to external sound.

On the other hand, when the wind noise detection unit 2000 determines that there is an influence (influence equal to or more than the predetermined value) of the wind noise (Step S15, “Yes” in FIG. 14), the control unit 2010 switches each of the switches 204(L) and 204(R) to the second input end and selects the FFNC filters 102b(L₂) and 102b(R₂) for wind. As a result, the influence of wind noise on the noise cancellation process is reduced.

As described above, in the second modification of the first embodiment, the presence or absence of wind noise is determined based on the sound signal output from the microphone 100b for the FF noise canceling system, and the FFNC filters 102b(L₁) and 102b(R₁) for non-wind and the FFNC filters 102b(L₂) and 102b(R₂) for wind are switched according to the determination result. Therefore, the influence of wind noise on the noise cancellation process can be reduced without increasing the number of microphones.

In addition, even when it is determined that the wind noise is generated and the FFNC filters 102b(L₁) and 102b(R₁) for wind are selected, the noise cancellation process by the FB noise canceling system is executed as usual, and it is possible to obtain the effect of noise cancellation.

In the example in FIG. 18, two FFNC filters for non-wind and wind are provided in each of the microphones 100b(L) and 100b(R) of the left and right channels, but the configuration is not limited thereto. For example, three or more FFNC filters may be provided in each of the microphones 100b(L) and 100b(R) of the left and right channels. For example, it is conceivable to add a filter having an intermediate characteristic between the FFNC filter for non-wind and the FFNC filter for wind.

### 4-4. Third Modification of First Embodiment

Next, a third modification of the first embodiment will be described. The third modification of the first embodiment is an example in which, with respect to the configuration according to the second modification of the first embodiment described with reference to FIG. 18, the buffer amplifier is provided for the output of each of the FFNC filters 102b(L₁) and 102b(R₁) for non-wind and the FFNC filters 102b(L₂) and 102b(R₂) for wind instead of the switches 204(L) and 204(R). In the wind noise detection and control unit 200, the control unit 2010 controls the output level of each buffer amplifier according to the detection result of the wind noise by the wind noise detection unit 2000.

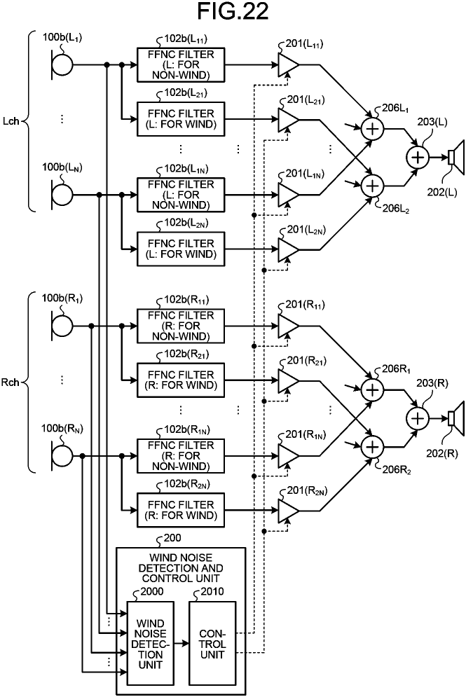

FIG. 19 is a block diagram of an example illustrating control by a wind noise detection and control unit according to the third modification of the first embodiment. In the left channel, outputs of the FFNC filters 102b(L₁) and 102b(L₂) are further combined by an adder 203(L) via buffer amplifiers 201(L₁) and 201(L₂) whose output levels are controlled by the control unit 2010, and supplied to the output device 202(L). Similarly, in the right channel, outputs of the FFNC filters 102b(R₁) and 102b(R₂) are further combined by an adder 203(R) via buffer amplifiers 201(R₁) and 201(R₂) whose output levels are controlled by the control unit 2010, and supplied to the output device 202(R).

The control unit 2010 controls the buffer amplifiers 201(L₁) and 201(L₂) and the buffer amplifiers 201(R₁) and 201(R₂) according to the detection result of the wind noise detection unit 2000.

More specifically, when the wind noise detection unit 2000 determines that there is no influence (influence less than the predetermined value) of the wind noise (Step S15, “No” in FIG. 14), the control unit 2010 controls the buffer amplifiers 201(L₁) and 201(R₁) to increase signal levels supplied from the FFNC filters 102b(L₁) and 102b(R₁) for non-wind to the adders 203(L) and 203(R). At the same time, the control unit 2010 controls the buffer amplifiers 201(L₂) and 201(R₂) so as to decrease signal levels supplied from the FFNC filters 102b(L₂) and 102b(R₂) for wind to the adders 203(L) and 203(R) .

On the other hand, when the wind noise detection unit 2000 determines that there is an influence (influence equal to or more than the predetermined value) of the wind noise (Step S15, “Yes” in FIG. 14), the control unit 2010 controls the buffer amplifiers 201(L₁) and 201(R₁) to decrease the signal levels supplied from the FFNC filters 102b(L₁) and 102b(R₁) for non-wind to the adders 203(L) and 203(R). At the same time, the control unit 2010 controls the buffer amplifiers 201(L₂) and 201(R₂) so as to decrease signal levels supplied from the FFNC filters 102b(L₂) and 102b(R₂) for wind to the adders 203(L) and 203(R).

Here, the control unit 2010 controls the output levels of the buffer amplifiers 201(L₁), 201(R₁), 201(L₂), and 201(R₂) to cross-fade between the outputs of the FFNC filters 102b(L₁) and 102b(R₁) for non-wind and the outputs of the FFNC filters 102b(L₂) and 102b(R₂) for wind.

As an example, a case of switching from a state of “no wind noise” to a state of “presence of wind noise” will be described. In the left channel, for example, the control unit 2010 gradually decreases the output level of the buffer amplifier 201(L₁) and gradually increases the output level of the buffer amplifier 201(L₂) to cross-fade the output of the buffer amplifier 201(L₁) and the output of the buffer amplifier 201(R₁) . Similarly, for the right channel, the control unit 2010 gradually changes the output levels of the buffer amplifiers 201(R₁) and 201(R₂), and cross-fades the outputs of the buffer amplifiers 201(R₁) and 201(R₂) .

The process is opposite to the above for switching from the state of “presence of wind noise” to the state of “no wind noise”.

As described above, in the third modification of the first embodiment, the switching between the state of “presence of wind noise” and the state of “no wind noise” is performed by cross-fading the output of the FFNC filter for non-wind and the output of the FFNC filter for wind. As a result, it is possible to reduce discomfort given to the listener at switching between the state of “presence of wind noise” and the state of “no wind noise”.

Also in the third modification of the first embodiment, similarly to the above, the presence or absence of wind noise is determined based on the sound signal output from the microphone 100b for the FF noise canceling system, and the outputs of the FFNC filters 102b(L₁) and 102b(R₁) for non-wind and the outputs of the FFNC filters 102b(L₂) and 102b(R₂) for wind are switched according to the determination result. Therefore, the influence of wind noise on the noise cancellation process can be reduced without increasing the number of microphones.

In addition, even when it is determined that the wind noise is generated and the FFNC filters 102b(L₁) and 102b(R₁) for wind are selected, the noise cancellation process by the FB noise canceling system is executed as usual, and it is possible to obtain the effect of noise cancellation.

In the configuration illustrated in FIG. 19, when the control unit 2010 decreases to zero the output levels of the buffer amplifiers not selected according to the detection result of the wind noise detection unit 2000 in the buffer amplifiers 201(L₁) and 201(R₁) and the buffer amplifiers 201(L₂) and 201(R₂), the operation of the FFNC filters corresponding to the buffer amplifiers not selected in the FFNC filters 102b(L₁) and 201b(L₂) and the FFNC filters 102b(R₁) and 102b(R₂) can be stopped. As a result, the number of filters that perform calculation simultaneously can be reduced, thereby reducing power consumption and increasing the processing speed.

### 4-5. Fourth Modification of First Embodiment

Next, a fourth modification of the first embodiment will be described. The fourth modification of the first embodiment is an example in which a microphone that is not used in the FB and FF noise canceling systems is added to the configuration of the third modification of the first embodiment described above.

FIG. 20 is a block diagram of an example illustrating control by a wind noise detection and control unit according to the fourth modification of the first embodiment. In the example in FIG. 20, a microphone 500 and a communication signal processing unit 501 are added to the above-described configuration in FIG. 19. A sound signal output from the microphone 500 and each sound signal output from the microphones 100b(L) and 100b(R) are supplied to the communication signal processing unit 501. For example, the communication signal processing unit 501 performs beamforming toward the mouth of the listener for voice transmission by sharing the sound signals output from the microphones 100b(L) and 100b(R) to generate a sound signal for voice transmission. For example, the communication signal processing unit 501 supplies the sound signal generated for voice transmission to the communication I/F 312(L).

Furthermore, the sound signal output from the microphone 500 is supplied to the wind noise detection and control unit 200 and input to the wind noise detection unit 2000. The wind noise detection unit 2000 detects the presence or absence of wind noise using three sound signals that are the sound signal supplied from each of the microphones 100b(L) and 100b(R) and the sound signal supplied from the microphone 500. For example, the wind noise detection unit 2000 extracts combinations of two sound signals from the three sound signals, and executes the wind noise detection process described with reference to FIG. 14 for each of the combinations extracted.

As described above, in the fourth modification of the first embodiment, by using the outputs of more number of microphones, it is possible to reduce the influence relating to the direction dependency of the FF-based noise canceling system and the wind noise detection in addition to the effects of the third modification of the first embodiment.

In the example in FIG. 19, the outputs of the FFNC filters 102b(L₁) and 102b(R₁) and the outputs of the FFNC filters 102b(L₁) and 102b(R₁) are cross-faded by controlling the output levels of the buffer amplifiers 201(L₁) and 201(R₁) and the buffer amplifiers 201(L₂) and 201(R₂), but the configuration is not limited thereto.

In other words, as described with reference to FIG. 16, the control unit 2010 may control the outputs of the FFNC filters 102b(L₁) and 102b(R₁) and the outputs of the FFNC filters 102b(L₁) and 102b(R₁) by the switches. Furthermore, as described with reference to FIG. 17, the control unit 2010 may control the filter coefficients of the FFNC filters 102b(L₁) and 102b(R₁) and the FFNC filters 102b(L₁) and 102b(R₁) .

### 4-6. Fifth Modification of First Embodiment

Next, a fifth modification of the first embodiment will be described. The fifth modification of the first embodiment is an example in which a plurality of microphones 100b is provided in each of the left and right channels, as compared with the third modification of the first embodiment described above.

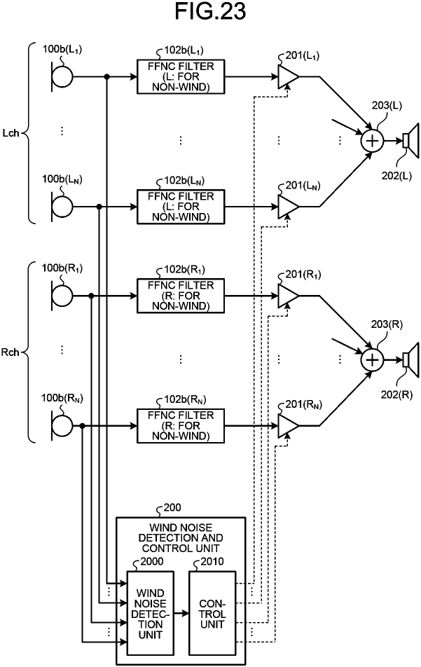

FIG. 21 is a block diagram of an example illustrating control by a wind noise detection and control unit according to the fifth modification of the first embodiment. In FIG. 21, N microphones 100b(L₁) to 100b(L_{N}) for the FF noise canceling system are provided in the left channel (Lch). Similarly, N microphones 100b(R₁) to 100b(R_{N}) are provided in the right channel (Rch). Sound signals output from the microphones 100b(L₁) to 100b(L_{N}) and the microphones 100b(R₁) to 101b(R_{N}) are supplied to the wind noise detection and control unit 200 and input to the wind noise detection unit 2000.

For example, the wind noise detection unit 2000 extracts combinations of two sound signals in each of the left and right channels from the sound signals output from the microphones 100b(L₁) to 100b(L_{N}) and the microphones 100b(R₁) to 100b(R_{N}), and performs the wind noise detection process described with reference to FIG. 14 on each of the combinations extracted.

Furthermore, for example, in the left channel, N FFNC filters 102b(L₁₁) to 102b(L_{1N}) for non-wind and N FFNC filters 102b(L₂₁) to 102b(L_{2N}) for wind are provided for the respective microphones 100b(L₁) to 100b(L_{N}) .

Outputs of the FFNC filters 102b(L₁₁) to 102b(L_{1N}) for non-wind in the left channel are combined by an adder 205(L₁) and supplied to the first input end of the adder 203(L) via the buffer amplifier 201(L₁) whose output level is controlled by the control unit 2010. Similarly, outputs of the FFNC filters 102b(R₁₁) to 102b(R_{1N}) for non-wind in the right channel are combined by an adder 205(R₁) and supplied to the first input end of the adder 203(R) via the buffer amplifier 201(R₁) whose output level is controlled by the control unit 2010.

Similarly, outputs of the FFNC filters 102b(L₂₁) to 102b(L_{2N}) for wind are combined by an adder 205(L₂) and supplied to the second input end of the adder 203(L) via the buffer amplifier 201(L₂) whose output level is controlled by the control unit 2010. In addition, outputs of the FFNC filters 102b(R₂₁) to 102b(R_{2N}) for non-wind in the right channel are combined by an adder 205(R₂) and supplied to the second input end of the adder 203(R) via the buffer amplifier 201(R₂) whose output level is controlled by the control unit 2010.

The adder 203(L) combines sound signals input to the first input end and the second input end, and supplies a combined sound signal to the output device 202(L). Similarly, the adder 203(R) combines sound signals input to the first input end and the second input end, and supplies a combined sound signal to the output device 202(R).

For example, as in the case of the third modification of the first embodiment described above, the control unit 2010 controls the output levels of the buffer amplifiers 201(L₁) and 201(L₂) to cross-fade between the output of the adder 205(L₁) obtained by combining the outputs of the FFNC filters 102b(L₁₁) to 102b(L_{1N}) for non-wind and the output of the adder 205(L₂) obtained by combining outputs of the FFNC filters 102b(L₂₁) to 102b(L_{2N}) for wind in the left channel.

As described above, in the fifth modification of the first embodiment, by using the outputs of more number of microphones, it is possible to reduce the influence relating to the direction dependency of the FF noise canceling system and the wind noise detection in addition to the effects of the third modification of the first embodiment described above.

In the example in FIG. 21, the outputs of the adders 205(L₁) and 205(R₁) and the outputs of the adders 205(R₁) and 205(R₂) can be cross-faded by controlling the output levels of the buffer amplifiers 201(L₁) and 201(R₁) and the buffer amplifiers 201(L₂) and 201(R₂), but the configuration is not limited thereto.

In other words, as described with reference to FIG. 18, the control unit 2010 may control the outputs of the adders 205(L₁) and 205(R₁) and the outputs of the adders 205(R₁) and 205(R₂) by the switches. Furthermore, as described with reference to FIG. 17, the control unit 2010 may control the filter coefficients of the FFNC filters 102b(L₁₁) to 102b(L_{1N}) and 102b(R₁₁) to 102b(R_{1N}), and the FFNC filters 102b(L₂₁) to 102b(L_{N}) and 102b(R₁₁) to 102b(R_{2N}) .

### 4-7. Sixth Modification of First Embodiment

Next, a sixth modification of the first embodiment will be described. In the configuration in which the plurality of microphones is provided in the left and right channels and the FFNC filters for non-wind and for wind are provided corresponding to the microphones, the fifth modification of the first embodiment described above switches the outputs of the FFNC filter for non-wind and the FFNC filter for wind after the outputs of the respective FFNC filters are combined. On the other hand, in the sixth modification of the first embodiment, the outputs of the FFNC filters are combined after the outputs of the FFNC filters are respectively controlled for non-wind and for wind.

FIG. 22 is a block diagram of an example illustrating control by a wind noise detection and control unit according to the sixth modification of the first embodiment. In FIG. 22, similarly to FIG. 21 described above, N microphones 100b(L₁) to 100b(L_{N}) for the FF noise canceling system are provided in the left channel. Similarly, N microphones 100b(R₁) to 100b(R_{N}) are provided in the right channel. Sound signals output from the microphones 100b(L₁) to 100b(L_{N}) and the microphones 100b(R₁) to 100b(R_{N}) are supplied to the wind noise detection and control unit 200 and input to the wind noise detection unit 2000.

For example, the wind noise detection unit 2000 extracts combinations of two sound signals in each of the left and right channels from the sound signals output from the microphones 100b(L₁) to 100b(L_{N}) and the microphones 100b(R₁) to 100b(R_{N}), and performs the wind noise detection process described with reference to FIG. 14 on each of the combinations extracted.

In the left channel, the N FFNC filters 102b(L₁₁) to 102b(L_{1N}) for non-wind and the N FFNC filters 102b(L₂₁) to 102b(L_{2N}) for wind are provided for each of the microphones 100b(L₁) to 100b(L_{N}) .

Outputs of the FFNC filters 102b(L₁₁) to 102b(L_{1N}) for non-wind in the left channel are supplied to an adder 206(L₁) via the respective buffer amplifiers 201(L₁₁) to 201(L_{1N}) whose output levels are controlled by the control unit 2010. The adder 206(L₁) combines the outputs of the buffer amplifiers 201(L₁₁) to 201(L_{1N}) and supplies a combined output to the first input end of the adder 203(L).

Outputs of the FFNC filters 102b(L₂₁) to 102b(L_{2N}) for wind in the left channel are supplied to an adder 206(L₂) via the respective buffer amplifiers 201(L₂₁) to 201(L_{2N}) whose output levels are controlled by the control unit 2010. The adder 206(L₂) combines the outputs of the buffer amplifiers 201(L₂₁) to 201(L_{2N}) and supplies a combined output to the second input end of the adder 203(L).

Similarly, outputs of the FFNC filters 102b(R₁₁) to 102b(R_{1N}) for non-wind in the right channel are supplied to the adder 206(R₁) via the respective buffer amplifiers 201(R₁₁) to 201(R_{1N}) whose output levels are controlled by the control unit 2010. The adder 206(R₁) combines the outputs of the buffer amplifiers 201(R₁₁) to 201(R_{1N}) and supplies a combined output to the first input end of the adder 203(R).

Outputs of the FFNC filters 102b(R₂₁) to 102b(R_{2N}) for wind in the right channel are supplied to an adder 206(R₂) via the respective buffer amplifiers 201(R₂₁) to 201(R_{2N}) whose output levels are controlled by the control unit 2010. The adder 206(R₂) combines the outputs of the buffer amplifiers 201(R₂₁) to 201(R_{2N}) and supplies a combined output to the first input end of the adder 203(R).

The adder 203(L) combines sound signals input to the first input end and the second input end, and supplies a combined sound signal to the output device 202(L). Similarly, the adder 203(R) combines sound signals input to the first input end and the second input end, and supplies a combined sound signal to the output device 202(R).

For example, in the left channel, the control unit 2010 controls the output levels of the buffer amplifiers 201(L₁₁) to 201(L_{1N}) and the output levels of the buffer amplifiers 201(L₂₁) to 201(L_{2N}) to cross-fade between each of the buffer amplifiers 201(L₁₁) to 201(L_{1N}) and each of the buffer amplifiers 201(L₂₁) to 201(L_{2N}) .

Similarly, in the right channel, the control unit 2010 controls the output levels of the buffer amplifiers 201(R₁₁) to 201(R_{1N}) and the output levels of the buffer amplifiers 201(R₂₁) to 201(R_{2N}) to cross-fade between each of the buffer amplifiers 201(R₁₁) to 201(R_{1N}) and each of the buffer amplifiers 201(R₂₁) to 201(R_{2N}) .

As described above, also in the sixth modification of the first embodiment, similarly to the fifth modification of the first embodiment described above, by using the outputs of more number of microphones, it is possible to reduce the influence relating to the direction dependency of the FF noise canceling system and the wind noise detection in addition to the effects of the third modification of the first embodiment described above.

Further, in the sixth modification of the first embodiment, similarly to the third modification of the first embodiment described above, when the control unit 2010 decreases to zero the output levels of the buffer amplifiers not selected according to the detection result of the wind noise detection unit 2000 in the buffer amplifiers 201(L₁₁) to 201(L_{1N}), the buffer amplifiers 201(R₁₁) to 201(R_{1N}), the buffer amplifiers 201(L₂₁) to 201(L_{2N}), and the buffer amplifiers 201(R₂₁) to 201(R_{2N}), the operation of the FFNC filters corresponding to the buffer amplifiers not selected in the FFNC filters 102b(L₁₁) to 102b(L_{1N}) and 102b(R₁₁) to 102b(R_{1N}) and the FFNC filters 102b(L₂₁) to 102b(L_{2N}) and 102b(R₂₁) to 102b(R_{2N}) can be stopped. As a result, the number of filters that perform calculation simultaneously can be reduced, thereby reducing power consumption and increasing the processing speed.

### 4-8. Seventh Modification of First Embodiment

Next, a seventh modification of the first embodiment will be described. The seventh modification of the first embodiment is an example of a case where a plurality of microphones for the FF noise canceling system is provided for each of the left and right channels with respect to the configuration according to the first embodiment described with reference to FIG. 16.

FIG. 23 is a block diagram of an example illustrating control by a wind noise detection and control unit according to the seventh modification of the first embodiment. In the left channel, the N microphones 100b(L₁) to 100b(L_{N}) for the FF noise canceling system are provided. Sound signals output from the microphones 100b(L₁) to 100b(L_{N}) are supplied to the wind noise detection and control unit 200 and input to the wind noise detection unit 2000.

For example, the wind noise detection unit 2000 extracts combinations of two sound signals from the sound signals output from the microphones 100b(L₁) to 100b(L_{N}), and executes the wind noise detection process described with reference to FIG. 14 for each of the combinations extracted.

The N FFNC filters 102b(L₁) to 102b(L_{N}) are provided for the microphones 100b(L₁) to 100b(L_{N}) on a one-to-one basis. Outputs of the FFNC filters 102b(L₁) to 102b(L_{N}) are combined by an adder 203L via the respective N buffer amplifiers 201(L₁) to 201(L_{N}) whose output levels are controlled by the control unit 2010, and are supplied to the output device 202(L).

Similarly, in the right channel, the N microphones 100b(R₁) to 100b(R_{N}) for the FF noise canceling system are provided, and the N FFNC filters 102b(R₁) to 102b(R_{N}) are provided on a one-to-one basis for the microphones 100b(R₁) to 100b(R_{N}) . Outputs of the FFNC filters 102b(R₁) to 102b(R_{N}) are combined by the adder 203(R) via the respective N buffer amplifiers 201(R₁) to 201(R_{N}) whose output levels are controlled by the control unit 2010, and are supplied to the output device 202(R).

The control unit 2010 controls the buffer amplifiers 201(L₁) to 201(L_{N}) and 201(R₁) to (R_{N}) according to the detection result of the wind noise detection unit 2000.

More specifically, when the wind noise detection unit 2000 determines that there is no influence (influence less than the predetermined value) of the wind noise (Step S15, “No” in FIG. 14), the control unit 2010 controls each of the buffer amplifiers 201(L₁) to 201(L_{N}) and each of the buffer amplifiers 201(R₁) to 201(R_{N}) so as to increase the signal level supplied from each of the FFNC filters 102b(L₁) to 102b(L_{N}) and each of the FFNC filters 102b(R₁) to 102b(R_{N}) to the adders 203(L) and 203(R).

On the other hand, when the wind noise detection unit 2000 determines that there is an influence (influence equal to or more than the predetermined value) of the wind noise (Step S15, “Yes” in FIG. 14), the control unit 2010 controls each of the buffer amplifiers 201(L₁) to 201(L_{N}) and each of the buffer amplifiers 201(R₁) to 201(R_{N}) so as to decrease (e.g., zero) the signal level supplied from each of the FFNC filters 102b(L₁) to 102b(L_{N}) and each of the FFNC filters 102b(R₁) to 102b(R_{N}) to the adders 203(L) and 203(R). As a result, the degree of noise cancellation with respect to noise due to the external sound is reduced, and the influence of wind noise on the noise cancellation process is reduced.

As described above, in addition to the effects of the first embodiment described with reference to FIG. 16, the seventh modification of the first embodiment can reduce the influence relating to the direction dependency of the FF noise canceling system and the wind noise detection by using the outputs of more number of microphones even when only the FFNC filter for non-wind is provided as the FFNC filter.

Note that the above description refers to the control unit 2010 simultaneously controlling the buffer amplifiers 201(L₁ to L_{N}) and the buffer amplifiers 201(R₁) to 201(R_{N}), but the control is not limited thereto. For example, the control unit 2010 can sequentially control, with a time shift, the buffer amplifiers 201(L₁ to L_{N}) and the buffer amplifiers 201(R₁) to 201(R_{N}) in each of the left and right channels.

In addition, in the example in FIG. 23, the output levels of the buffer amplifiers 201(L₁) to 201(L_{N}) and the buffer amplifiers 201(R₁) to 201(R_{N}) are controlled, but the control is not limited thereto.

In other words, as described with reference to FIG. 18, the control unit 2010 may control the outputs of the adders 205(L₁) and 205(R₁) and the outputs of the adders 205(R₁) and 205(R₂) by the switches. Furthermore, as described with reference to FIG. 17, the control unit 2010 may control the filter coefficients of the FFNC filters 102b(L₁) to 102b(L_{N}) and 102b(R₁) to 102b(R_{N}).

### 5. Second Embodiment

Next, a second embodiment of the present disclosure will be described. The second embodiment is an example in which a filter for an ambient sound monitoring system is applied instead of the FFNC filter 102b in the first embodiment and the modifications thereof described above.

### 5-1. Configuration Example of Second Embodiment

A configuration example of the second embodiment will be described. As described with reference to FIG. 5A, the FFNC filter that can be used in the FF noise canceling system and the filter for the ambient sound monitoring system only have different transfer functions. Therefore, in each configuration described with reference to FIGS. 16 to 23, it is possible to realize the ambient sound monitoring system in consideration of wind noise by replacing the FFNC filter with a filter for the ambient sound monitoring system.

Hereinafter, the filter for the ambient sound monitoring system is referred to as an HT filter for convenience. More specifically, the HT filter here includes a filter that realizes a hear-through (HT) state in which external sound is captured as naturally as possible, and a filter that realizes a state in which a specific frequency band(e.g., frequency band related to conversation) of ambient sound is selectively captured.

FIG. 24 is a functional block diagram of an example illustrating control by a wind noise detection and control unit 200 according to the second embodiment. The configuration illustrated in FIG. 24 corresponds to FIG. 16 described above, and HT filters 102d(L) and 102d(R) are provided instead of the FFNC filters 102b(L) and 102b(R) in FIG. 16. For example, each of the HT filters 102d(L) and 102d(R) corresponds to the HT filter 102d of the transfer function “γ” described with reference to FIGS. 5A to 5C. Further, microphones 100b(L) and 100b(R) are used for capturing ambient sound. Other parts in FIG. 24 are similar to corresponding parts in FIG. 16, and thus the description thereof is omitted here.

In FIG. 24, as in the first embodiment, the wind noise detection unit 2000 of the wind noise detection and control unit 200 executes the process in Step S11L and Steps S11R to S15 of the flowchart in FIG. 14, and the control unit 2010 executes the process in Step S16 of the flowchart in FIG. 14.

As in the first embodiment, the control unit 2010 adjusts a degree of control of hearing (how the sound is heard) by the listener of sound output from the output devices 202(L) and 202(R) depending on a detection result of a presence or absence of wind noise by the wind noise detection unit 2000 between a degree of control when it is determined that the wind noise has been detected and a degree of control when it is determined that no wind noise has been detected. In other words, the wind noise detection and control unit 200 including the wind noise detection unit 2000 and the control unit 2010 functions as an adjustment unit that adjusts the degree of control of the hearing of the sound output from the output devices 202(L) and 202(R) to the listener between the degree of control when it is determined that a wind noise has been detected and the degree of control when it is determined that the wind noise has not been detected.

### 51. Control According to Detection Result of Wind noise

In FIG. 24, an output level of the HT filter 102d(L) for a left channel is adjusted by the buffer amplifier 201(L) and supplied to the output device 202(L). Similarly, an output level of the HT filter 102d(R) for a right channel is adjusted by the buffer amplifier 201(R) and supplied to the output device 202(R).

Note that an addition unit 104a or 104b that combines sound source signals is inserted(not illustrated) between the buffer amplifier 201(L) and the output device 202(L) and between the buffer amplifier 201(R) and the output device 202(R), respectively.

The control unit 2010 controls the buffer amplifiers 201(L) and 201(R) according to the detection result of the wind noise detection unit 2000. More specifically, when the wind noise detection unit 2000 determines that there is no influence (influence less than a predetermined value) of wind noise (Step S15, “No” in FIG. 14), the control unit 2010 controls the buffer amplifiers 201(R) and 201(L) to increase signal levels supplied from the HT filters 102d(L) and 102d(R) to the output devices 202(L) and 202(R). For example, the control unit 2010 controls the buffer amplifiers 201(R) and 201(L) so as to obtain the maximum output. As a result, sound output from each of the output devices 202(L) and 202(R) becomes sound in which ambient sound is captured.

On the other hand, when the wind noise detection unit 2000 determines that there is an influence (influence equal to or more than the predetermined value) of the wind noise (Step S15, “Yes” in FIG. 14), the control unit 2010 controls the buffer amplifiers 201(R) and 201(L) to decrease the signal levels supplied from the HT filters 102d(L) and 102d(R) to the output devices 202(L) and 202(R). For example, the control unit 2010 controls the output levels of the buffer amplifiers 201(R) and 201(L) to be zero. As a result, a degree of capturing the ambient sound is reduced, and the influence of wind noise on an ambient sound capturing process is reduced.

As described above, in the second embodiment, the presence or absence of wind noise is determined based on the sound signals output from the microphones 100b(L) and 100b(R) for capturing the ambient sound, and a degree of capturing the ambient sound by the ambient sound monitoring system is controlled according to the determination result. Therefore, the influence of wind noise on the ambient sound capturing process can be reduced without increasing the number of microphones.

### 5-2. First Modification of Second Embodiment

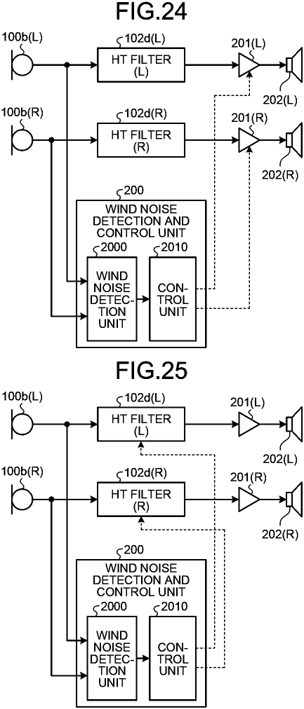

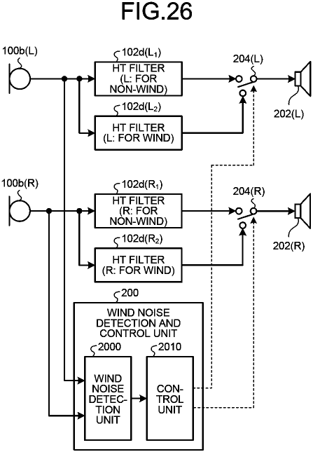

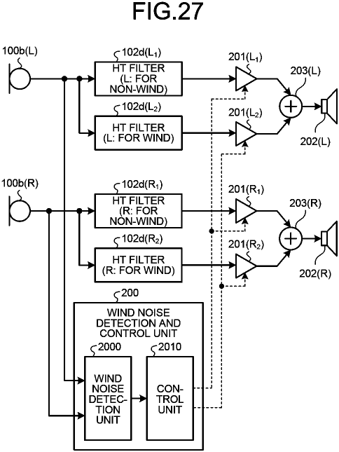

Next, a first modification of the second embodiment will be described. The first modification of the second embodiment corresponds to the first modification of the first embodiment described above. FIG. 25 is a diagram corresponding to FIG. 17 described above, and is a block diagram of an example illustrating control by the wind noise detection and control unit 200 according to the first modification of the second embodiment.

In FIG. 25, the outputs of the HT filters 102d(L) and 102d(R) are supplied to the output devices 202(L) and 202(R) via buffer amplifiers 201(L) and 201(R), respectively. Note that an addition unit 104a or 104b that combines sound source signals is inserted(not illustrated) between the buffer amplifier 201(L) and the output device 202(L) and between the buffer amplifier 201(R) and the output device 202(R), respectively.

The control unit 2010 controls filter coefficients of the HT filters 102d(L) and 102d(R) according to the detection result of the wind noise detection unit 2000.

More specifically, when the wind noise detection unit 2000 determines that there is no influence (influence less than the predetermined value) of the wind noise (Step S15, “No” in FIG. 14), the control unit 2010 controls the filter coefficients of the HT filters 102d(L) and 102d(R) to execute the ambient sound capturing process by the ambient sound monitoring system as usual. As a result, sound output from each of the output devices 202(L) and 202(R) becomes sound in which ambient sound is captured.

On the other hand, when the wind noise detection unit 2000 determines that there is an influence (influence equal to or more than the predetermined value) of wind noise (Step S15, “Yes” in FIG. 14), the control unit 2010 controls the filter coefficients of the HT filters 102d(L) and 102d(R) so as to decrease the degree of capturing the ambient sound by the ambient sound monitoring system. For example, the control unit 2010 controls the filter coefficients of the HT filters 102d(L) and 102d(R) such that the outputs of the HT filters 102d(L) and 102d(R) become zero. Accordingly, the degree of capturing the ambient sound is decreased and the influence of wind noise on capturing the ambient sound is reduced.

As described above, in the second modification of the second embodiment, the presence or absence of wind noise is determined based on the sound signals output from the microphones 100b(L) and 100b(R), and the degree of capturing the ambient sound by the ambient sound monitoring system is controlled according to the determination result. Therefore, the influence of wind noise on the ambient sound capturing process can be reduced without increasing the number of microphones.

### 5-3. Second Modification of Second Embodiment

Next, a second modification of the second embodiment will be described. The second modification of the second embodiment corresponds to the second modification of the first embodiment described above. The second modification of the second embodiment is an example in which the HT filter 102d for wind and the HT filter 102d for non-wind are provided in each of the left and right channels.

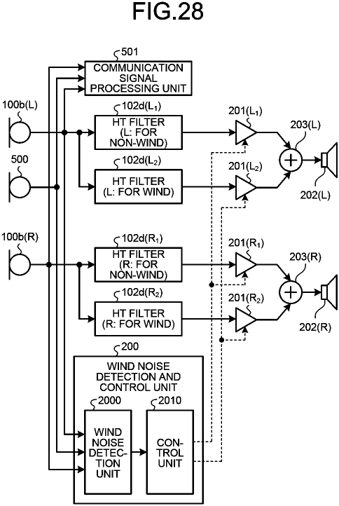

FIG. 26 is a diagram corresponding to FIG. 18 described above, and is a block diagram of an example illustrating control by a wind noise detection and control unit according to the second modification of the second embodiment. In the left channel, the sound signal output from the microphone 100b(L) is supplied to an HT filter 102d(L₁) for non-wind and an HT filter 102d(L₂) for wind. Outputs of the HT filters 102d(L₁) and 102d(L₂) are respectively supplied to the first input end and the second input end of the switch 204(L) whose switching is controlled by the control unit 2010. An output from an output end of the switch 204(L) is supplied to the output device 202(L).

Similarly in the right channel, the sound signal output from the microphone 100b(R) is supplied to an HT filter 102d(R₁) for non-wind and an HT filter 102d(R₂) for wind. Outputs of the HT filters 102d(R₁) and 102d(R₂) are respectively supplied to the first input end and the second input end of the switch 204(R) whose switching is controlled by the control unit 2010. An output from an output end of the switch 204(R) is supplied to the output device 202(R).

Here, the HT filters 102d(L₁) and 102d(R₁) for non-wind have characteristics equivalent to those of the HT filters 102d(L) and 102d(R) in FIG. 16 described above. In other words, the HT filters 102d(L₁) and 102d(R₁) for non-wind have characteristics that do not take wind noise into consideration.

On the other hand, the HT filters 102d(L₂) and 102d(R₂) for wind are filters having characteristics considering wind noise as compared with the above-described HT filters 102d(L₁) and 102d(R₁) for non-wind. As an example, the HT filters 102d(L₂) and 102d(R₂) for wind have characteristics in which the degree of capturing the ambient sound is lower than that of the HT filters 102d(L₁) and 102d(R₁) or zero in a main frequency band of wind noise (e.g., frequency band from 200 [Hz] to 100 [Hz] or less) with respect to the characteristics of the HT filters 102d(L₁) and 102d(R₁) for non-wind.

The control unit 2010 controls switching by the switches 204(L) and 204(R) according to the detection result of the wind noise detection unit 2000.

More specifically, when the wind noise detection unit 2000 determines that there is no influence (influence less than the predetermined value) of the wind noise (Step S15, “No” in FIG. 14), the control unit 2010 switches each of the switches 204(L) and 204(R) to the first input end and selects the HT filters 102d(L₁) and 102d(R₁) for non-wind. As a result, sound output from each of the output devices 202(L) and 202(R) becomes sound in which ambient sound is captured.

On the other hand, when the wind noise detection unit 2000 determines that there is an influence (influence equal to or more than the predetermined value) of wind noise (Step S15, “Yes” in FIG. 14), the control unit 2010 switches each of the switches 204(L) and 204(R) to the second input end and selects the HT filters 102d(L₂) and 102d(R₂) for wind. As a result, the influence of wind noise on the ambient sound capturing process is reduced.

As described above, in the second modification of the second embodiment, the presence or absence of wind noise is determined based on the sound signals output from the microphones 100b(L) and 100(R), and the HT filters 102d(L₁) and 102d(R₁) for non-wind and the HT filters 102d(L₂) and 102d(R₂) for wind are switched according to the determination result. Therefore, the influence of wind noise on the ambient sound capturing process can be reduced without increasing the number of microphones.

In the example in FIG. 26, two HT filters for non-wind and for wind are provided for each of the microphones 100b(L) and 100b(R) in the left and right channels, but the configuration is not limited thereto. For example, three or more HT filters may be provided for each of the microphones 100b(L) and 100b(R) in the left and right channels. For example, it is conceivable to add a filter having an intermediate characteristic between the HT filter for non-wind and the HT filter for wind.

### 5-4. Third Modification of Second Embodiment

Next, a third modification of the second embodiment will be described. The third modification of the second embodiment corresponds to the third modification of the first embodiment described above. The third modification of the second embodiment is an example in which buffer amplifiers are provided for the outputs of the HT filters 102d(L₁) and 102d(R₁) for non-wind and the HT filters 102d(L₂) and 102d(R₂) for wind, respectively, instead of the switches 204(L) and 204(R), with respect to the configuration according to the second modification of the second embodiment described with reference to FIG. 26. In the wind noise detection and control unit 200, the control unit 2010 controls the output level of each buffer amplifier according to the detection result of the wind noise by the wind noise detection unit 2000.

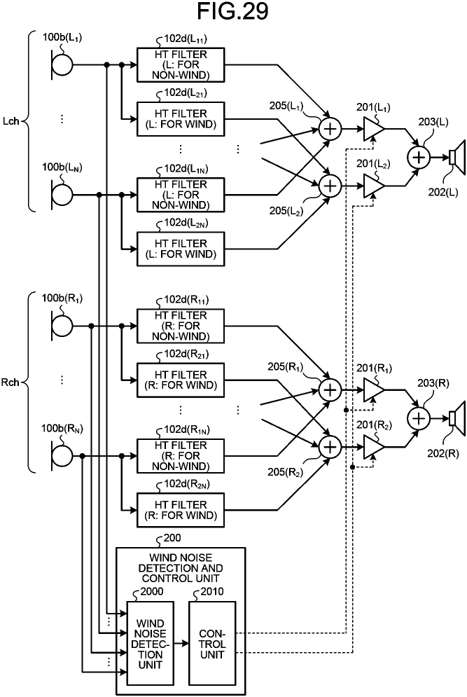

FIG. 27 is a diagram corresponding to FIG. 19 described above, and is a block diagram of an example illustrating control by a wind noise detection and control unit according to the third modification of the second embodiment. In the left channel, the outputs of the HT filters 102d(L₁) and 102d(L₂) are further combined by the adder 203(L) via the buffer amplifiers 201(L₁) and 201(L₂) whose output levels are controlled by the control unit 2010, and supplied to the output device 202(L). Similarly, in the right channel, the outputs of the HT filters 102d(R₁) and 102d(R₂) are further combined by the adder 203(R) via the buffer amplifiers 201(R₁) and 201(R₂) whose output levels are controlled by the control unit 2010, and supplied to the output device 202(R).

The control unit 2010 controls the buffer amplifiers 201(L₁) and 201(L₂) and the buffer amplifiers 201(R₁) and 201(R₂) according to the detection result of the wind noise detection unit 2000.

More specifically, when the wind noise detection unit 2000 determines that there is no influence (influence less than the predetermined value) of the wind noise (Step S15, “No” in FIG. 14), the control unit 2010 controls the buffer amplifiers 201(L₁) and 201(R₁) to increase the signal levels supplied from the HT filters 102d(L₁) and 102d(R₁) for non-wind to the adders 203(L) and 203(R). At the same time, the control unit 2010 controls the buffer amplifiers 201(L₂) and 201(R₂) so as to decrease the signal levels supplied from the HT filters 102d(L₂) and 102d(R₂) for wind to the adders 203(L) and 203(R).

On the other hand, when the wind noise detection unit 2000 determines that there is an influence (influence equal to or more than the predetermined value) of wind noise (Step S15, “Yes” in FIG. 14), the control unit 2010 controls the buffer amplifiers 201(L₁) and 201(R₁) to lower the signal levels supplied from the HT filters 102d(L₁) and 102d(R₁) for non-wind to the adders 203(L) and 203(R). At the same time, the control unit 2010 controls the buffer amplifiers 201(L₂) and 201(R₂) so as to decrease the signal levels supplied from the HT filters 102d(L₂) and 102d(R₂) for wind to the adders 203(L) and 203(R).

Here, the control unit 2010 controls the output levels of the buffer amplifiers 201(L₁) and 201(R₁) and 201(L₂) and 201(R₂) to cross-fade between the outputs of the HT filters 102d(L₁) and 102d(R₁) for non-wind and the outputs of the HT filters 102d(L₂) and 102d(R₂) for wind.

As described above, in the third modification of the second embodiment, the switching between the state of “presence of wind noise” and the state of “no wind noise” is performed by cross-fading the output of the FFNC filter for non-wind and the output of the FFNC filter for wind. As a result, it is possible to reduce discomfort given to the listener at switching between the state of “presence of wind noise” and the state of “no wind noise”.

Also in the third modification of the second embodiment, similarly to the above description, the presence or absence of wind noise is determined based on the sound signals output from the microphones 100b(L) and 100b(R), and the outputs of the HT filters 102d(L₁) and 102d(R₁) for non-wind and the outputs of the HT filters 102d(L₂) and 102d(R₂) for wind are switched according to the determination result. Therefore, the influence of wind noise on the ambient sound capturing process can be reduced without increasing the number of microphones.

Note that, in the configuration illustrated in FIG. 27, when the control unit 2010 decreases to zero the output levels of the buffer amplifiers not selected according to the detection result of the wind noise detection unit 2000 in the buffer amplifiers 201(L₁) and 201(R₁) and the buffer amplifiers 201(L₂) and 201(R₂), the operation of the HT filters corresponding to the buffer amplifiers not selected in the HT filters 102d(L₁) and 102d(L₂) and the HT filters 102d(R₁) and 102d(R₂) can be stopped. As a result, the number of filters that perform calculation simultaneously can be reduced, thereby reducing power consumption and increasing the processing speed.

### 5-5. Fourth Modification of Second Embodiment

Next, a fourth modification of the second embodiment will be described. The fourth modification of the second embodiment corresponds to the fourth modification of the first embodiment described above, and is an example of a case where a microphone not used for the ambient sound monitoring system is added to the configuration of the third modification of the second embodiment.

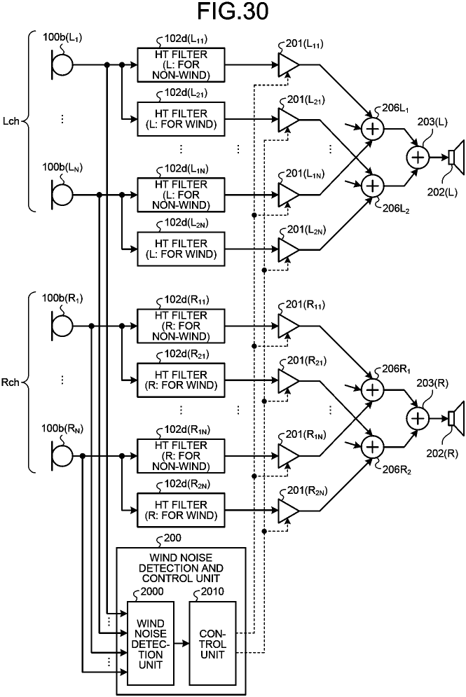

FIG. 28 is a diagram corresponding to FIG. 20 described above, and is a block diagram of an example illustrating control by a wind noise detection and control unit according to the fourth modification of the second embodiment. In FIG. 28, a sound signal output from the microphone 500 and sound signals output from the microphones 100b(L) and 100b(R) are supplied to the communication signal processing unit 501.

Furthermore, the sound signal output from the microphone 500 is supplied to the wind noise detection and control unit 200 and input to the wind noise detection unit 2000. The wind noise detection unit 2000 detects the presence or absence of wind noise using three sound signals that are the sound signal supplied from each of the microphones 100b(L) and 100b(R) and the sound signal supplied from the microphone 500. For example, the wind noise detection unit 2000 extracts combinations of two sound signals from the three sound signals, and executes the wind noise detection process described with reference to FIG. 14 for each of the combinations extracted.

As described above, in the fourth modification of the second embodiment, by using the outputs of more number of microphones, it is possible to reduce the influence relating to the direction dependency of the ambient sound monitoring system and the wind noise detection in addition to the effects of the third modification of the second embodiment described above.

In the example in FIG. 19, the outputs of the HT filters 102d(L₁) and 102d(R₁) and the outputs of the HT filters 102d(L₁) and 102d(R₁) are cross-faded by controlling the output levels of the buffer amplifiers 201(L₁) and 201(R₁) and the buffer amplifiers 201(L₂) and 201(R₂), but the configuration is not limited thereto.

In other words, as described with reference to FIG. 24, the control unit 2010 may control the outputs of the HT filters 102d(L₁) and 102d(R₁) and the outputs of the HT filters 102d(L₁) and 102d(R₁) by the switches. Furthermore, as described with reference to FIG. 25, the control unit 2010 may control the filter coefficients of the HT filters 102d(L₁) and 102d(R₁) and the HT filters 102d(L₁) and 102d(R₁).

### 5-6. Fifth Modification of Second Embodiment

Next, a fifth modification of the second embodiment will be described. The fifth modification of the second embodiment is an example in which a plurality of microphones 100b is provided in each of the left and right channels, as compared with the third modification of the second embodiment described above.

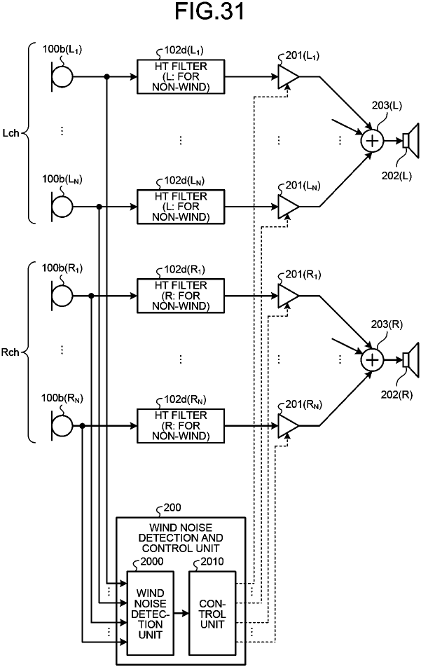

FIG. 29 is a diagram corresponding to FIG. 21 described above, and is a block diagram of an example illustrating control by a wind noise detection and control unit according to the fifth modification of the second embodiment. In FIG. 29, N microphones 100b(L₁) to 100d(L_{N}) are provided in the left channel. Similarly, N microphones 100b(R₁) to 100b(R_{N}) are provided in the right channel (Rch). Sound signals output from the microphones 100b(L₁) to 100b(L_{N}) and the microphones 100b(R₁) to 100b(R_{N}) are supplied to the wind noise detection and control unit 200 and input to the wind noise detection unit 2000.

For example, the wind noise detection unit 2000 extracts combinations of two sound signals in each of the left and right channels from the sound signals output from the microphones 100b(L₁) to 100b(L_{N}) and the microphones 100b(R₁) to 100b(R_{N}), and performs the wind noise detection process described with reference to FIG. 14 on each of the combinations extracted.

Furthermore, for example, in the left channel, N HT filters 102d(L₁₁) to 102d(L_{1N}) for non-wind and N HT filters 102d(L₂₁) to 102d(L_{2N}) for wind are provided for each of the microphones 100b(L₁) to 100b(L_{N}).

Outputs of the HT filters 102d(L₁₁) to 102(L_{1N}) for non-wind in the left channel are combined by the adder 205(L₁) and supplied to the first input end of the adder 203(L) via the buffer amplifier 201(L₁) whose output level is controlled by the control unit 2010. Similarly, the outputs of the HT filters 102d (R₁₁) to 102d(R_{1N}) for non-wind in the right channel are combined by the adder 205(R₁) and supplied to the first input end of the adder 203(R) via the buffer amplifier 201(R₁) whose output level is controlled by the control unit 2010.

Similarly, the outputs of the HT filters 102d(L₂₁) to 102d(L_{2N}) for wind are combined by the adder 205(L₂) and supplied to the second input end of the adder 203(L) via the buffer amplifier 201(L₂) whose output level is controlled by the control unit 2010. In addition, the outputs of the HT filters 102d(R₂₁) to 102d(R_{2N}) for non-wind in the right channel are combined by the adder 205(R₂) and supplied to the second input end of the adder 203(R) via the buffer amplifier 201(R₂) whose output level is controlled by the control unit 2010.

The adder 203(L) combines sound signals input to the first input end and the second input end, and supplies a combined sound signal to the output device 202(L). Similarly, the adder 203(R) combines sound signals input to the first input end and the second input end, and supplies a combined sound signal to the output device 202(R).

For example, as in the third modification of the second embodiment described above, the control unit 2010 controls the output levels of the buffer amplifiers 201(L₁) and 201(L₂) to cross-fade between the output of the adder 205(L₁) obtained by combining the outputs of the HT filters 102d(L₁₁) to 102d(L_{1N}) for non-wind and the output of the adder 205(L₂) obtained by combining the outputs of the HT filters 102d(L₂₁) to 102d(L_{2N}) for wind in the left channel.

As described above, in the fifth modification of the second embodiment, by using the outputs of more number of microphones, it is possible to reduce the influence relating to the direction dependency of the ambient sound monitoring system and the wind noise detection in addition to the effects of the third modification of the second embodiment described above.

In the example in FIG. 29, the outputs of the adders 205(L₁) and 205(R₁) and the outputs of the adders 205(R₁) and 205(R₂) can be cross-faded by controlling the output levels of the buffer amplifiers 201(L₁) and 201(R₁) and the buffer amplifiers 201(L₂) and 201(R₂), but the configuration is not limited thereto.

In other words, as described with reference to FIG. 26, the control unit 2010 may control the outputs of the adders 205(L₁) and 205(R₁) and the outputs of the adders 205(R₁) and 205(R₂) by the switches. Furthermore, as described with reference to FIG. 25, the control unit 2010 may control the filter coefficients of the HT filters 102d(L₁₁) to 102d(L_{1N}) and 102d(R₁₁) to 102d(R_{1N}), and the HT filters 102d(L₂₁) to 102d(L_{N}) and 102d(R₁₁) to 102d(R_{2N}).

### 5-7. Sixth Modification of Second Embodiment

Next, a sixth modification of the second embodiment will be described. The sixth modification of the second embodiment corresponds to the sixth modification of the first embodiment described above. In the configuration in which the plurality of microphones is provided in the left and right channels and the HT filters for non-wind and for wind are provided corresponding to the microphones, the fifth modification of the second embodiment described above switches the output of the HT filter for non-wind and the output of the HT filter for wind after the outputs of the respective HT filters are combined. On the other hand, in the sixth modification of the second embodiment, the outputs of the respective HT filters are combined after the outputs of the respective HT filters for non-wind and for wind are controlled.

FIG. 30 corresponds to FIG. 22 described above, and is a block diagram of an example illustrating control by a wind noise detection and control unit according to the sixth modification of the second embodiment. In FIG. 30, similarly to FIG. 29 described above, the N microphones 100b(L₁) to 100b(L_{N}) and the N microphones 100b(R₁) to 100b(R_{N}) are provided in each of the left and right channels. The sound signals output from the microphones 100b(L₁) to 100b(L_{N}) and the microphones 100b(R₁) to 100d(R_{N}) are supplied to the wind noise detection and control unit 200 and input to the wind noise detection unit 2000.

For example, the wind noise detection unit 2000 extracts combinations of two sound signals for each of the left and right channels from the sound signals output from the microphones 100b(L₁) to 100b(L_{N}) and the microphones 100b(R₁) to 100d(R_{N}), and performs the wind noise detection process described with reference to FIG. 14 on each of the combinations extracted.

In the left channel, the N HT filters 100d(L₁₁) to 100d(L_{1N}) for non-wind and the N HT filters 102d(L₂₁) to 102d(L_{2N}) for wind are provided for the microphones 102b(L₁) to 102d(L_{N}), respectively.

Outputs of the HT filters 102d(L₁₁) to 102d(L_{1N}) for non-wind in the left channel are supplied to the adder 206 (L₁) via the respective buffer amplifiers 201(L₁₁) to 201(L_{1N}) whose output levels are controlled by the control unit 2010. The adder 206(L₁) combines the outputs of the buffer amplifiers 201(L₁₁) to 201(L_{1N}) and supplies a combined output to the first input end of the adder 203(L).

Outputs of the HT filters 102d(L₂₁) to 102d(L_{2N}) for wind in the left-channel are supplied to the adder 206 (L₂) via the respective buffer amplifiers 201(L₂₁) to 201(L_{2N}) whose output levels are controlled by the control unit 2010. The adder 206(L₂) combines the outputs of the buffer amplifiers 201(L₂₁) to 201(L_{2N}) and supplies a combined output to the second input end of the adder 203(L).

Similarly, the outputs of the HT filters 102d(R₁₁) to 102d(R_{1N}) for non-wind in the right channel are supplied to the adder 206 (R₁) via the respective buffer amplifiers 201(R₁₁) to 201(R_{1N}) whose output levels are controlled by the control unit 2010. The adder 206 (R₁) combines the outputs of the buffer amplifiers 201(R₁₁) to 201(R_{1N}) and supplies a combined output to the first input end of the adder 203(R).

Outputs of the HT filters 102d(R₂₁) to 102d(R_{2N}) for wind in the right-channel are supplied to the adder 206 (R₂) via the respective buffer amplifiers 201(R₂₁) to 201(R_{2N}) whose output levels are controlled by the control unit 2010. The adder 206 (R₂) combines the outputs of the buffer amplifiers 201(R₂₁) to 201(R_{2N}) and supplies a combined output to the first input end of the adder 203(R).

The adder 203(L) combines sound signals input to the first input end and the second input end, and supplies a combined sound signal to the output device 202(L). Similarly, the adder 203(R) combines sound signals input to the first input end and the second input end, and supplies a combined sound signal to the output device 202(R).

For example, in the left channel, the control unit 2010 controls the output levels of the buffer amplifiers 201(L₁₁) to 201(L_{1N}) and the output levels of the buffer amplifiers 201(L₂₁) to 201(L_{2N}) to cross-fade between each of the buffer amplifiers 201(L₁₁) to 201(L_{1N}) and each of the buffer amplifiers 201(L₂₁) to 201(L_{2N}).

Similarly, in the right channel, the control unit 2010 controls the output levels of the buffer amplifiers 201(R₁₁) to 201(R_{1N}) and the output levels of the buffer amplifiers 201(R₂₁) to 201(R_{2N}) to cross-fade between each of the buffer amplifiers 201(R₁₁) to 201(R_{1N}) and each of the buffer amplifiers 201(R₂₁) to 201(R_{2N}).

As described above, also in the sixth modification of the second embodiment, similarly to the fifth modification of the second embodiment described above, by using the outputs of more number of microphones, it is possible to reduce the influence relating to the direction dependency of the ambient sound monitoring system and the wind noise detection in addition to the effects of the third modification of the second embodiment described above.

Further, in the sixth modification of the second embodiment, similarly to the third modification of the second embodiment described above, when the control unit 2010 decreases to zero the output levels of the buffer amplifiers not selected according to the detection result of the wind noise detection unit 2000 in the buffer amplifiers 201(L₁₁) to 201(L_{1N}) and the buffer amplifiers 201(R₁₁) to 201(R_{1N}), the buffer amplifiers 201(L₂₁) to 201(L_{2N}) and the buffer amplifiers 201(R₂₁) to 201(R_{2N}), the operation of the HT filters corresponding to the buffer amplifiers not selected in the HT filters 102d(L₁₁) to 102d(L_{1N}) and 102d(R₁₁) to 102d(R_{1N}), the HT filters 102d(L₂₁) to 102d(L_{2N}) and 102d(R₂₁) to 102d(R_{2N}) can be stopped. As a result, the number of filters that perform calculation simultaneously can be reduced, thereby reducing power consumption and increasing the processing speed.

### 5-8. Seventh Modification of Second Embodiment

Next, a seventh modification of the second embodiment will be described. The seventh modification of the second embodiment is an example of a case where a plurality of microphones for the ambient sound monitoring system is provided for each of the left and right channels with respect to the configuration according to the second embodiment described with reference to FIG. 24.

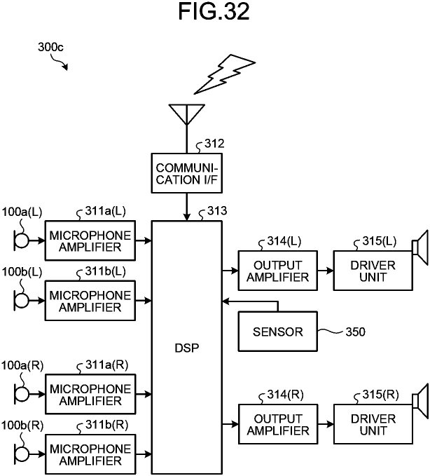

FIG. 31 is a diagram corresponding to FIG. 23 described above, and is a block diagram of an example illustrating control by a wind noise detection and control unit according to the seventh modification of the second embodiment. The N microphones 100b(L₁) to 100b(L_{N}) are provided in the left channel. Sound signals output from the microphones 100b(L₁) to 100b(L_{N}) are supplied to the wind noise detection and control unit 200 and input to the wind noise detection unit 2000.

For example, the wind noise detection unit 2000 extracts combinations of two sound signals from the sound signals output from the microphones 100b(L₁) to 100b(L_{N}), and executes the wind noise detection process described with reference to FIG. 14 for each of the combinations extracted.

The N HT filters 100d(L₁) to 100d(L_{N}) are provided, on a one-to-one basis, for the microphones 102b(L₁) to 102b(L_{N}). Outputs of the HT filters 102d(L₁) to 102d(L_{N}) are combined by the adder 203L via the respective N buffer amplifiers 201(L₁) to 201(L_{N}) whose output levels are controlled by the control unit 2010, and are supplied to the output device 202(L).

Similarly, in the right channel, the N microphones 100b(R₁) to 100b(R_{N}) for the ambient sound monitoring system are provided and the N HT filters 102d(R₁) to 102d(R_{N}) are provided, on a one-to-one basis, for the microphones 100b(R₁) to 100b(R_{N}). The outputs of the HT filters 102d(R₁) to 102d(R_{N}) are combined by the adder 203(R) via the respective N buffer amplifiers 201(R₁) to 201(R_{N}) whose output levels are controlled by the control unit 2010, and are supplied to the output device 202(R).

The control unit 2010 controls the buffer amplifiers 201(L₁) to 201(L_{N}) and 201(R₁) to (R_{N}) according to the detection result of the wind noise detection unit 2000.

More specifically, when the wind noise detection unit 2000 determines that there is no influence (influence less than a predetermined value) of wind noise (Step S15, “No” in FIG. 14), the control unit 2010 controls each of the buffer amplifiers 201(L₁) to 201(L_{N}) and each of the buffer amplifiers 201(R₁) to 201(R_{N}) so as to increase the signal levels supplied from each of the HT filters 102d(L₁) to 102d(L_{N}) and each of the HT filters 102d(R₁) to 102d(R_{N}) to the adders 203(L) and 203(R).

On the other hand, when the wind noise detection unit 2000 determines that there is an influence (influence equal to or more than the predetermined value) of the wind noise (Step S15, “Yes” in FIG. 14), the control unit 2010 controls each of the buffer amplifiers 201(L₁) to 201(L_{N}) and each of the buffer amplifiers 201(R₁) to 201(R_{N}) so as to lower (e.g., zero) the signal levels supplied from each of the HT filters 102d(L₁) to 102d(L_{N}) and each of the HT filters 102d(R₁) to 102d(R_{N}) to the adders 203(L) and 203(R). As a result, the degree of capturing the ambient sound is reduced, and the influence of wind noise on the ambient sound capturing process is reduced.

As described above, in the seventh modification of the second embodiment, even in a case where only the HT filter for non-wind is provided as the HT filter, it is possible to reduce the influence relating to the direction dependency of the ambient sound monitoring system and the wind noise detection by using the outputs of more number of microphones in addition to the effects of the second embodiment described with reference to FIG. 24.

Note that the above description refers to the control unit 2010 simultaneously controlling the buffer amplifiers 201(L₁ to L_{N}) and the buffer amplifiers 201(R₁) to 201(R_{N}), but the control is not limited thereto. For example, the control unit 2010 can sequentially control, with a time shift, the buffer amplifiers 201(L₁ to L_{N}) and the buffer amplifiers 201(R₁) to 201(R_{N}) in each of the left and right channels.

In addition, in the example in FIG. 23, the output levels of the buffer amplifiers 201(L₁) to 201(L_{N}) and the buffer amplifiers 201(R₁) to 201(R_{N}) are controlled, but the control is not limited thereto.

In other words, as described with reference to FIG. 18, the control unit 2010 may control the outputs of the adders 205(L₁) and 205(R₁) and the outputs of the adders 205(R₁) and 205(R₂) by the switches. Furthermore, as described with reference to FIG. 17, the control unit 2010 may control the filter coefficients of the HT filters 102d(L₁) to 102d(L_{N}) and 102d(R₁) to 102d(R_{N}).

### 6. Third Embodiment

Next, a third embodiment of the present disclosure will be described. In the third embodiment, a degree of control by the FF noise canceling system or a degree of control by the ambient sound monitoring system is changed according to a behavior of a listener wearing the sound output apparatus (earphone or headphone) according to the present disclosure or the environment in which the listener is present.

For example, so-called building wind in a building street and wind during walking on a non-windy day blow relatively intermittently. In addition, wind while riding a bike or running, outdoor wind on a windy day, and wind from air conditioning in a fixed wind direction blow relatively continuously. Further, wind from an air conditioner or an electric fan having an automatic airflow direction adjusting function blows in a specific direction in a fixed cycle.

For the wind that blows continuously, it is preferable to operate the above-described process of reducing the influence of wind noise on the FF noise canceling system or the ambient sound monitoring system. On the other hand, with respect to the wind that blows intermittently, there is a case where the wind blows only for an extremely short time, and thus it is not necessary to sensitively operate the reduction process. For the wind blowing in a fixed cycle, even when the wind seems to have stopped, it may be better to continue to operate the reduction process for a while.

Therefore, in the third embodiment, a wind noise detection parameter, a threshold for determining whether or not the reduction process is executed, time until returning to an original state, and the like are adjusted according to temporal transition or frequency of the detection result of the wind noise.

More specifically, a detector that detects the behavior or environment of the listener is provided in the configurations according to the first embodiment and the modifications thereof and the second embodiment and the modifications thereof described above. The detector may detect a position, a moving speed, and an altitude (atmospheric pressure) using a global navigation satellite system (GNSS) or an acceleration sensor, and apply a weather forecast (weather information) including wind speed. Based on a detection result by the detector, the above-described process of reducing the influence on the FF noise canceling system or the ambient sound monitoring system is controlled. As a result, it is possible to realize a preferable user experience (UX) for the listener.

Furthermore, thresholds (first threshold and second threshold) and the like for determining whether or not to execute the reduction process can be learned through, for example, feedback of comfort/discomfort from the listener. This feedback of comfort/discomfort from the listener can be acquired by, for example, application software installed in a smartphone, an operator (e.g., a switch or a touch sensor) provided in a main body of an earphone or a headphone or a remote control commander, or a biological signal such as brain waves of the listener.

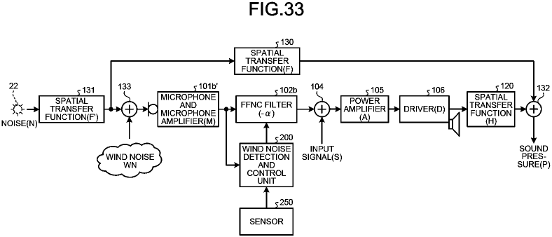

FIG. 32 is a hardware block diagram of an example of a sound output apparatus 300b according to the third embodiment. The sound output apparatus 300c illustrated in FIG. 32 is obtained by adding a sensor 350 to the sound output apparatus 300a illustrated in FIG. 15B described above. A detection result of the sensor 350 is supplied to, for example, the DSP 313. Since the hardware configuration of the sound output apparatus 300b illustrated in FIG. 32 is equivalent to that of the sound output apparatus 300a in FIG. 15 except for the sensor 350, the description thereof will be omitted here.

The configuration is not limited thereto, and the sensor 350 can be provided in the configuration including the DSPs 313(L) and 313(R) independently in the left channel and the right channel as illustrated in FIG. 15A described above. In this case, the detection result of the sensor 350 is supplied to at least one of the DSPs 313(L) and 313(R).

The third embodiment is applicable to the first embodiment and the modifications thereof and the second embodiment and the modifications thereof described above. Hereinafter, the third embodiment will be described as being applied to the first embodiment in which the process by the FF noise canceling system is performed. For example, the sound output apparatus 300b includes the configuration of FIG. 16 described above, and controls the signal levels of the noise cancellation signals supplied from the FFNC filters 102b(L) and 102b(R) to the output devices 202(L) and 202(R) according to the detection result of the wind noise by the wind noise detection and control unit 200.

In FIG. 32, as described above, the sensor 350 may be a position detection device supporting GNSS or an acceleration sensor. An altimeter (barometer) can also be applied as the sensor 350. Furthermore, a device that acquires a biological signal of the listener can also be applied as the sensor 350. Furthermore, the sensor 350 may include a plurality of types of detection devices. Note that, in the example in FIG. 32, the sensor 350 is illustrated to be built in the sound output apparatus 300b, but the configuration is not limited thereto For example, the sensor 350 can be configured as an external device of the sound output apparatus 300b, and the detection result can be transmitted to the DSP 313(L) by wired or wireless communication. Furthermore, as the sensor 350, various sensors built in another existing device (e.g., smartphone) or the like capable of communicating with the sound output apparatus 300b can also be applied.

FIG. 33 is a diagram illustrating an example of a configuration of an FF noise canceling system according to the third embodiment. The configuration illustrated in FIG. 33 is obtained by adding the sensor 350 to the configuration illustrated in FIG. 13 described above. The configuration illustrated in FIG. 33 is equivalent to the configuration illustrated in FIG. 13 except for the sensor 350, and thus the description thereof will be omitted. Here, the description will be given assuming that the sensor 350 includes at least the position detection sensor and the acceleration sensor. The sensor 350 can further include means for acquiring information on weather, such as a weather forecast.

In FIG. 33, a detection result of the sensor 350 is supplied to the wind noise detection and control unit 200. The wind noise detection and control unit 200 controls the characteristics of the FFNC filter 102b according to the detection result of the wind noise and the detection result of the sensor 350.

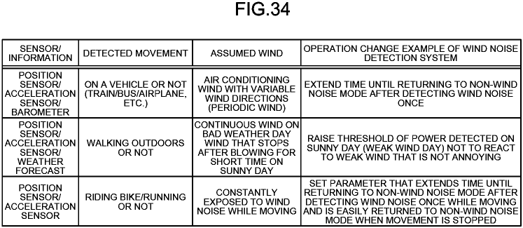

FIG. 34 is a schematic diagram illustrating an example of an operation according to the detection result of the sensor 350 according to the third embodiment. FIG. 34 illustrates a sensor and an information type to be used, a movement (behavior) of the listener detected based on the sensor and the information, wind assumed with respect to the behavior, and an operation change example of the system with respect to the behavior and wind.

In FIG. 34, as a first example, the wind noise detection and control unit 200 can detect whether or not the listener wearing the sound output apparatus 300b is on a vehicle by using the position sensor, the acceleration sensor, and the barometer as the sensor and information. Note that the vehicle refers to a moving object in which the listener is present in a container such as a train, a bus, and an airplane. In this case, assumed wind is, for example, air conditioning with variable wind directions. In other words, the wind periodically changes with respect to the listener. For such wind, for example, it is conceivable that the wind noise detection and control unit 200 extends time until returning to the non-wind noise mode (control mode of not detecting wind noise) after detecting the wind noise once.

As a second example, the wind noise detection and control unit 200 can detect whether or not the listener wearing the sound output apparatus 300b is walking outdoors by using the position sensor, the acceleration sensor, and information based on the weather forecast (weather information) as the sensor and information. In this case, the assumed wind is, for example, wind that blows continuously on a bad weather day or weak wind that stops after blowing for a short time on a sunny day. It is conceivable that the wind noise detection and control unit 200 raises the threshold of the determination in Step S15 with respect to the wind power calculated in Steps S13L and S13R in FIG. 14 on a fine day (a weak wind day) so as not to react to such a weak wind that is not annoying.

As a third example, the wind noise detection and control unit 200 can detect whether or not the listener wearing the sound output apparatus 300b is riding bike or running by using the position sensor and the acceleration sensor as the sensor and information. In this case, assumed wind is wind that the listener is constantly exposed while moving by bike or running. With respect to such wind, it is conceivable that the wind noise detection and control unit 200 sets a parameter that extends the time until returning to the non-wind noise mode after detecting the wind noise once while the listener is moving, and is easily returned to the non-wind noise mode when the moving speed becomes equal to or less than a predetermined value (for example, when the movement stops).

As described above, by changing the control by the wind noise detection and control unit 200 according to the detection result of the sensor 350, the listener can receive the process of reducing the influence of the wind noise according to the situation without operating each time the sound output apparatus 300b worn by the listener or the terminal device communicable with the sound output apparatus 300b.

For example, which of the first example, the second example, and the third example described above to execute can be determined by the wind noise detection and control unit 200 according to the output of the sensor 350. However, the present disclosure is not limited thereto, and the determination can be made according to an instruction by a user (e.g., listener) according to a user interface (UI) formed in a terminal device (smartphone, portable sound reproduction device, etc.) communicable with the sound output apparatus 300b, for example, by the communication I/F 312(L). In this case, not only the selection of any one of the first example, the second example, and the third example, but whether to execute the process of reducing the influence of wind noise, the execution timing, and the like can be set using further detailed items.

Note that the effects described in the present specification are merely examples and not limited, and other effects may be provided.

Note that the present technology can also have the following configurations.
(1) A signal processing device comprising:
   two or more microphones each provided with a sound collection part directed to an outside of a housing including a driver unit;
   a control unit that performs a hearing control on sound output from the driver unit to a listener based on each of sound signals collected and output by each of the two or more microphones; and
   an adjustment unit that adjusts a degree of the hearing control, based on a correlation between the sound signals, between a degree for wind and a degree for non-wind.
(2) The signal processing device according to the above (1), wherein
   the adjustment unit
   adjusts a degree of control of an output of a filter between the degree for wind and the degree for non-wind, the filter being provided for the hearing control by the control unit.
(3) The signal processing device according to the above (1) or (2), wherein
   the adjustment unit
   adjusts the degree of the hearing control based on the correlation between the sound signals and power of the each of the sound signals.
(4) The signal processing device according to the above (3), wherein
   the adjustment unit
   adjusts the degree of the hearing control such that the degree for wind is higher than the degree for non-wind when an absolute value of the correlation is less than a first threshold and the power is equal to or more than a second threshold.
(5) The signal processing device according to the above (1) or (2), wherein
   the adjustment unit
   adjusts the degree of the hearing control using an artificial intelligence, the artificial intelligence performing learning using the sound signals as an input and the degree for wind and the degree for non-wind as an output.
(6) The signal processing device according to any one of the above (1) to (5), further comprising
   an acquisition unit that acquires state information indicating a state of the housing, wherein
   the adjustment unit
   adjusts the degree of the hearing control further using the state information acquired by the acquisition unit.
(7) The signal processing device according to the above (6), wherein
   the acquisition unit
   acquires, as the state information, information indicating at least one of a position of the housing, acceleration of the housing, and an environment in which the housing is placed.
(8) The signal processing device according to the above (6) or (7), further comprising
   a communication unit that communicates with a terminal device, wherein
   the adjustment unit
   follows an instruction received by the communication unit from the terminal device to adjust the degree of the hearing control using the state information acquired by the acquisition unit.
(9) The signal processing device according to any one of the above (2) to (8), wherein
   the adjustment unit
   uses an output level of the filter as a degree of control to adjust the degree of control between the degree for wind and the degree for non-wind.
(10) The signal processing device according to the above (9), wherein
   the adjustment unit
   adjusts the output level of the filter such that the output level of the filter is zero in one of the degree for wind and the degree for non-wind and other than zero in an other of the degree for wind and the degree for non-wind.
(11) The signal processing device according to the above (9) or (10), wherein
   the filter includes
   a first filter for wind and a second filter for non-wind, and
   the adjustment unit
   adjusts an output level of the first filter and an output level of the second filter.
(12) The signal processing device according to the above (11), wherein
   the adjustment unit
   cross-fades the output level of the first filter and the output level of the second filter.
(13) The signal processing device according to the above (11) or (12), wherein
   a set of the first filter and the second filter is provided for the each of the sound signals, and
   the adjustment unit
   adjusts the output level of the first filter and the output level of the second filter in each of a plurality of the sets, combines an adjusted output of the first filter in the each of the sets to generate a first combined output, combines an adjusted output of the second filter in the each of the sets to generate a second combined output, and further combines and outputs the first combined output and the second combined output.
(14) The signal processing device according to the above (11) or (12), wherein
   a set of the first filter and the second filter is provided for the each of the sound signals, and
   the adjustment unit
   combines an output of the first filter in each of a plurality of the sets to generate a first combined output, adjusts a level of the first combined output, combines an output of the second filter in each of the sets to generate a second combined output, adjusts a level of the second combined output, and further combines and outputs the first combined output and the second combined output whose levels have been adjusted.
(15) The signal processing device according to any one of the above (1) to (14), wherein
   the control unit
   performs the hearing control, based on the each of the sound signals, by removing an external noise component from a sound source signal to be supplied to the driver unit, the external noise component being caused by external sound leaking from the outside into the housing.
(16) The signal processing device according to any one of the above (1) to (14), wherein
   the control unit
   performs the hearing control, based on the each of the sound signals, by adding a sound component in a predetermined frequency band in sound of the outside to a sound source signal to be supplied to the driver unit.
(17) The signal processing device according to any one of the above (1) to (14), wherein
   the control unit
   switches, according to an instruction, between:
   a process of performing the hearing control, based on the each of the sound signals, by removing an external noise component from a sound source signal to be supplied to the driver unit, the external noise component being caused by external sound leaking from the outside into the housing, and
   a process of performing the hearing control, based on the each of the sound signals, by adding a sound component of a predetermined frequency band in sound of the outside to a sound source signal to be supplied to the driver unit.
(18) A signal processing program causing a processor to execute:
   a control step of performing a hearing control on sound output from a driver unit to a listener based on each of sound signals collected and output by each of two or more microphones each provided with a sound collection unit directed to an outside of a housing including the driver unit; and
   an adjustment step of adjusting a degree of the hearing control between a degree for wind and a degree for non-wind based on a correlation between the sound signals.
(19) A signal processing method executed by a processor, the method comprising:
   a control step of performing a hearing control on sound output from a driver unit to a listener based on each of sound signals collected and output by each of two or more microphones each provided with a sound collection unit directed to an outside of a housing including the driver unit; and
   an adjustment step of adjusting a degree of the hearing control between a degree for wind and a degree for non-wind based on a correlation between the sound signals.

10_{FB}, 10_{FF}, 10_{OH} HEADPHONE
10_{EWL}, 10_{wD} EARPHONE
100a, 100b, 100b(L), 100b(L₁), 100b(L_{N}), 100b(R), 100b(R₁), 100b(R_{N}), 100_{C11}, 100_{C12}, 100_{C21}, 100_{C22}, 100_{C23}, 100_{C31}, 100_{C32}, 100_{C33}, 500 MICROPHONE
102a, 1020 FILTER
102b, 102b(L), 102b(L₁), 102b(L_{N}), 102b(R), 102b(R₁), 102b(R_{N}) FFNC FILTER
102d, 102d(L), 102d(L₁), 102d(L_{N}), 102d(R), 102d(R₁), 102d(R_{N}) HT FILTER
104, 121, 131, 132, 133, 203(L), 203(R), 205(L₁), 205(L₂), 205(R₁), 205(R₂), 206 (L₁), 206 (L₂), 206 (R₁), 206 (R₂) ADDER
200 WIND NOISE DETECTION AND CONTROL UNIT
201(L), 201(L₁), 201(L_{N}), 201(R), 201(R₁), 201(R_{N}) BUFFER AMPLIFIER
202(L), 202(R) OUTPUT DEVICE
312, 312(L) COMMUNICATION I/F
313, 313(L), 313(R) DSP
350 SENSOR
2000 WIND NOISE DETECTION UNIT
2010 CONTROL UNIT

1. A signal processing device comprising:
two or more microphones each provided with a sound collection part directed to an outside of a housing including a driver unit;
a control unit that performs a hearing control on sound output from the driver unit to a listener based on each of sound signals collected and output by each of the two or more microphones; and
an adjustment unit that adjusts a degree of the hearing control, based on a correlation between the sound signals, between a degree for wind and a degree for non-wind.

2. The signal processing device according to claim 1, wherein
the adjustment unit
adjusts a degree of control of an output of a filter between the degree for wind and the degree for non-wind, the filter being provided for the hearing control by the control unit.

3. The signal processing device according to claim 1, wherein
the adjustment unit
adjusts the degree of the hearing control based on the correlation between the sound signals and power of the each of the sound signals.

4. The signal processing device according to claim 3, wherein
the adjustment unit
adjusts the degree of the hearing control such that the degree for wind is higher than the degree for non-wind when an absolute value of the correlation is less than a first threshold and the power is equal to or more than a second threshold.

5. The signal processing device according to claim 1, wherein
the adjustment unit
adjusts the degree of the hearing control using an artificial intelligence, the artificial intelligence performing learning using the sound signals as an input and the degree for wind and the degree for non-wind as an output.

6. The signal processing device according to claim 1, further comprising
an acquisition unit that acquires state information indicating a state of the housing, wherein
the adjustment unit
adjusts the degree of the hearing control further using the state information acquired by the acquisition unit.

7. The signal processing device according to claim 6, wherein
the acquisition unit
acquires, as the state information, information indicating at least one of a position of the housing, acceleration of the housing, and an environment in which the housing is placed.

8. The signal processing device according to claim 6, further comprising
a communication unit that communicates with a terminal device, wherein
the adjustment unit
follows an instruction received by the communication unit from the terminal device to adjust the degree of the hearing control using the state information acquired by the acquisition unit.

9. The signal processing device according to claim 2, wherein
the adjustment unit
uses an output level of the filter as a degree of control to adjust the degree of control between the degree for wind and the degree for non-wind.

10. The signal processing device according to claim 9, wherein
the adjustment unit
adjusts the output level of the filter such that the output level of the filter is zero in one of the degree for wind and the degree for non-wind and other than zero in an other of the degree for wind and the degree for non-wind.

11. The signal processing device according to claim 9, wherein
the filter includes
a first filter for wind and a second filter for non-wind, and
the adjustment unit
adjusts an output level of the first filter and an output level of the second filter.

12. The signal processing device according to claim 11, wherein
the adjustment unit
cross-fades the output level of the first filter and the output level of the second filter.

13. The signal processing device according to claim 11, wherein
a set of the first filter and the second filter is provided for the each of the sound signals, and
the adjustment unit
adjusts the output level of the first filter and the output level of the second filter in each of a plurality of the sets, combines an adjusted output of the first filter in the each of the sets to generate a first combined output, combines an adjusted output of the second filter in the each of the sets to generate a second combined output, and further combines and outputs the first combined output and the second combined output.

14. The signal processing device according to claim 11, wherein
a set of the first filter and the second filter is provided for the each of the sound signals, and
the adjustment unit
combines an output of the first filter in each of a plurality of the sets to generate a first combined output, adjusts a level of the first combined output, combines an output of the second filter in each of the sets to generate a second combined output, adjusts a level of the second combined output, and further combines and outputs the first combined output and the second combined output whose levels have been adjusted.

15. The signal processing device according to claim 1, wherein
the control unit
performs the hearing control, based on the each of the sound signals, by removing an external noise component from a sound source signal to be supplied to the driver unit, the external noise component being caused by external sound leaking from the outside into the housing.

16. The signal processing device according to claim 1, wherein
the control unit
performs the hearing control, based on the each of the sound signals, by adding a sound component in a predetermined frequency band in sound of the outside to a sound source signal to be supplied to the driver unit.

17. The signal processing device according to claim 1, wherein
the control unit
switches, according to an instruction, between:
a process of performing the hearing control, based on the each of the sound signals, by removing an external noise component from a sound source signal to be supplied to the driver unit, the external noise component being caused by external sound leaking from the outside into the housing, and
a process of performing the hearing control, based on the each of the sound signals, by adding a sound component of a predetermined frequency band in sound of the outside to a sound source signal to be supplied to the driver unit.

18. A signal processing program causing a processor to execute:
a control step of performing a hearing control on sound output from a driver unit to a listener based on each of sound signals collected and output by each of two or more microphones each provided with a sound collection unit directed to an outside of a housing including the driver unit; and
an adjustment step of adjusting a degree of the hearing control between a degree for wind and a degree for non-wind based on a correlation between the sound signals.

19. A signal processing method executed by a processor, the method comprising:
a control step of performing a hearing control on sound output from a driver unit to a listener based on each of sound signals collected and output by each of two or more microphones each provided with a sound collection unit directed to an outside of a housing including the driver unit; and
an adjustment step of adjusting a degree of the hearing control between a degree for wind and a degree for non-wind based on a correlation between the sound signals.
